(19) United States
(12) Patent Application Publication
(10) Pub. No.: US 2011/0186796 A1
(43) Pub. Date: Aug. 4, 2011

(54) FENCING SYSTEM AND POST INSERT FOR USE THEREWITH

(76) Inventor: ROBERT E. PLATT, MINERAL RIDGE, OH (US)

(21) Appl. No.: 13/085,147

(22) Filed: Apr. 12, 2011

Related U.S. Application Data
(63) Continuation-in-part of application No. 12/571,887, filed on Oct. 1, 2009.
Application No. 12/571,887 is a continuation-in-part of application No. 11/818,738, filed on Jun. 15, 2007.
Application No. 11/818,738 is a continuation-in-part of application No. 11/046,499, filed on Jan. 28, 2005, now Pat. No. 7,407,152.

(51) Int. Cl. E04H 17/22; B23P 17/04

(52) U.S. Cl. 256/65.14; 29/428

(57) ABSTRACT

A fencing system typically includes hollow posts with rail structures extending therebetween. A post mount assembly is configured to mount on a foundation and is slidably received within each hollow post to provide suitable support for the posts. In one embodiment, each post mount assembly includes a wedge which is wedged against the post mount assembly typically to force the post mount assembly against an inner surface of the post. The post mount assembly may include a post mount and a post insert which is vertically adjustable relative to the post mount and against which the wedge is wedged.

### CROSS REFERENCE TO RELATED APPLICATIONS

This application is a continuation-in-part of U.S. patent application Ser. No. 12/571,887, filed Oct. 1, 2009, which is a continuation-in-part of U.S. patent application Ser. No. 11/818,738 filed on Jun. 15, 2007, which is a continuation-in-part of U.S. Ser. No. 11/046,499 filed on Jan. 28, 2005, now U.S. Pat. No. 7,407,152, the disclosures of which are incorporated herein by reference.

### BACKGROUND OF THE INVENTION

1. Technical Field

The invention relates generally to a fencing system or railing system. More particularly, the invention relates to a fencing system having a post support which provides sturdy mounting of the railing structure. Specifically, the invention relates to such a post support or post mount assembly typically having a post insert mounted atop a post mount with the railing structure secured to the post insert and/or hollow post in which the post support is received. The post support may include an expandable portion which braces the post from within and is adjustable to be used with different sized posts.

2. Background Information

Fencing and railing systems commonly utilize vertically mounted post structures with horizontal railing structures extending between and mounted on adjacent post structures. It is known in the art to utilize a post mount which is mounted on the ground or to a floor structure of some sort with the post mount slidably received within a hollow post whereby various types of structure attached to the post mount engages the inner surface of the post in order to provide support to the post. The various structure mounted on the post mount to help support the post either is disposed closely adjacent the inner surface of the post or in contact with said inner surface. One example of such a configuration is disclosed in U.S. Pat. No. 6,141,928 granted to the Applicant. Said patent discloses a post mount having fins or other outwardly projecting structure formed integrally therewith which frictionally engage the inner surface of the post to provide support thereto. Another example is disclosed in U.S. Pat. No. 6,718,710 granted to the Applicant. Said patent discloses a post mount having a head seated atop the post mount with a plurality of tabs extending outwardly therefrom which frictionally engage the inner surface of the post to provide support thereto. Both of said patents are incorporated herein by reference. Other post mounts are known in the art which have somewhat similar structures.

While these patents and other structures provide suitable support to the post for many purposes, there remains a need in the art for a connection between the railing structure and the post structures whereby said connection is substantially sturdier than those presently known. Most typically, the railing structures are secured by a fastener typically in the form of a screw or bolt to the post itself. Especially for railing structures that are elevated substantially above the ground or floor to which the post mount is attached, such a connection is not as sturdy as desired for certain applications. There is also a need for post supports which are sturdy, simple and easy to install.

### BRIEF SUMMARY OF THE INVENTION

The present invention provides a fencing system comprising: a post mount assembly having an upper end and a lower end adapted to mount on a foundation; a post having an inner surface defining a post cavity in which the post mount assembly is slidably receivable; a post mount of the post mount assembly; a first wall of the post mount assembly which is vertically slidable relative to the post mount; and a wedge of the post mount assembly which is movable relative to the post mount and first wall from a first position to a wedged position in which the wedge is wedged against the first wall.

The present invention also provides for a fencing system comprising: a post mount assembly comprising a post mount having an upper end and a lower end adapted to mount on a foundation; a post having an inner surface defining a post cavity in which the post mount assembly is slidably receivable; a first wall of the post mount assembly; a wedge of the post mount assembly which has a top and a bottom; a through passage formed in the wedge from the top to the bottom; wherein the wedge is downwardly movable relative to the post mount with the post mount received in the through passage from a first position to a wedged position in which the wedge is wedged against the first wall.

The present invention further provides a method comprising the steps of: securing a lower end of a post mount assembly to a foundation so that the post mount assembly extends upwardly from the foundation; inserting the post mount assembly into a post cavity defined by an inner surface of a post; and wedging a wedge of the post mount assembly against a first wall of the post mount assembly to force the post mount assembly against the inner surface of the post.

### BRIEF DESCRIPTION OF THE SEVERAL VIEWS OF THE DRAWINGS

Preferred embodiments of the invention, illustrative of the best modes in which applicant contemplates applying the principles, are set forth in the following description and are shown in the drawings and are particularly and distinctly pointed out and set forth in the appended claims.

FIG. 1 is an elevational view showing a first embodiment of the fence system of the present invention with the posts and railing structures in solid lines and the post mount, post insert and related structure in dashed lines.

FIG. 2 is an elevational view of a first embodiment of the post insert of the present invention.

FIG. 3 is a bottom plan view of the first embodiment of the post insert shown in FIG. 2.

FIG. 4 is an enlarged fragmentary sectional view of a portion of FIG. 1 showing the first embodiment of the post insert in relation to the various other structures of the fence system.

FIG. 5 is similar to FIG. 4 and shows a second embodiment of the post insert of the present invention.

FIG. 6 is an elevational view of a third embodiment of the post insert of the present invention.

FIG. 7 is a bottom plan view of the third embodiment.

FIG. 8 is a sectional view similar to FIG. 4 showing the third embodiment of the post insert in relation to various other structures of the third embodiment of the fence system.

FIG. 9 is an elevational view showing a second embodiment of the fence system of the present invention with the posts and railing structures in solid lines and the post mount and post insert of a further embodiment and related structure in dashed lines.

FIG. 10 is an elevational view of the post insert wherein the post insert includes flexible fingers defining a post insert cavity.

FIG. 11 is a top plan view of the post insert shown in FIG. 9.

FIG. 12 is an enlarged sectional view of the post insert taken along line 12-12 of FIG. 11.

FIG. 13 is a side elevational view of an expander wedge.

FIG. 14 is a top plan view of the expander wedge of FIG. 13.

FIG. 15 is an exploded perspective view showing the expander wedge positioned above and prior to insertion into the post insert within a structural member shown in section.

FIG. 16 is a sectional view taken along line 16-16 of FIG. 15.

FIG. 17 is a perspective view similar to FIG. 15 showing the expander wedge inserted into the post insert cavity of the post insert.

FIG. 18 is a sectional view similar to FIG. 16 showing the expander wedge inserted into the post insert cavity of the post insert.

FIG. 19 is a sectional view taken along line 19-19 of FIG. 18.

FIG. 20 is a sectional view similar to FIG. 18 of the fencing system showing the rail structures and cap member mounted on the post.

FIG. 21 is a side elevational view showing a third embodiment of the fence system of the present invention with the post and railing structures in solid lines and the post mount assembly of a further embodiment in dashed lines.

FIG. 22 is a side elevational view of the post insert of FIG. 21.

FIG. 23 is a top plan view of the post insert of FIG. 22.

FIG. 24 is an enlarged sectional view taken on lines 24-24 of FIG. 23.

FIG. 25 is a side elevational view of a second embodiment of the expander wedge.

FIG. 26 is a top plan view of the wedge of FIG. 25.

FIG. 27 is a sectional view similar to FIG. 16 of the analogous portion of the post and post mount assembly of FIG. 21.

FIG. 28 is a sectional view similar to FIG. 18 of the post and post mount assembly shown in FIG. 27.

FIG. 29 is a sectional view taken on line 29-29 of FIG. 28.

FIG. 30 is similar to FIG. 28 and shows rail structures mounted on the post.

Similar numbers refer to similar parts throughout the specification.

### DETAILED DESCRIPTION OF THE INVENTION

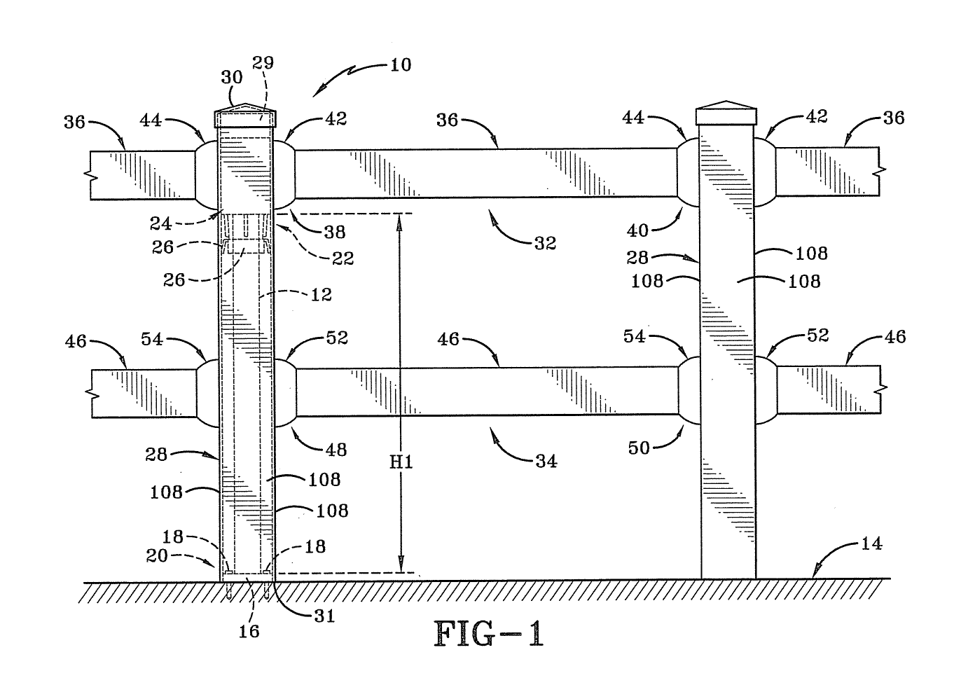

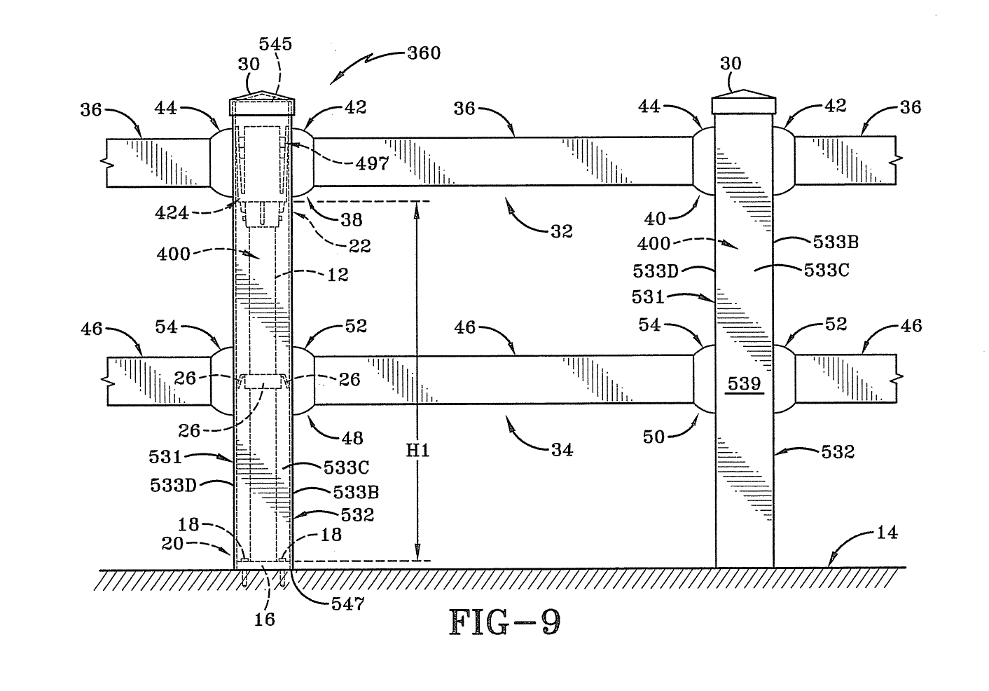

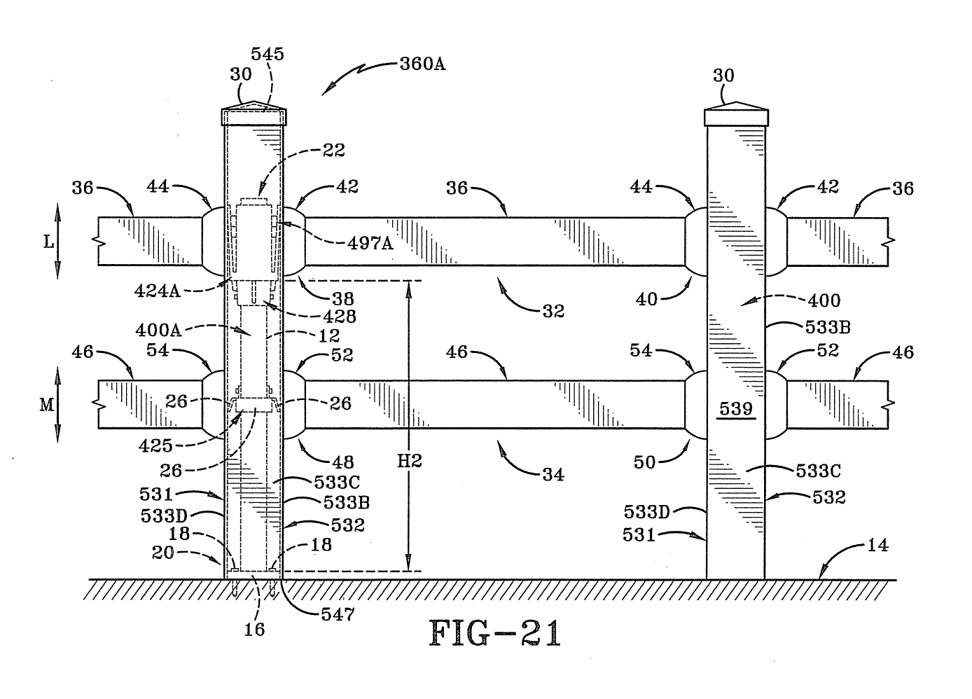

A first embodiment of the fencing system of the present invention is indicated generally at 10 in FIG. 1; a second embodiment of the fencing system of the present invention is indicated generally at 360 in FIG. 9; and a third embodiment of the fencing system of the present invention is indicated generally at 360A in FIG. 21. System 10 includes a post mount 12 which is mounted on a foundation or base structure 14 such as a floorboard of a floor or platform, a concrete floor or the like or the ground itself. Post mount 12 is typically mounted on a plate 16 adjacent a lower end 20 thereof by welding, for example, and mounted via plate 16 to base structure 14 via bolts 18 or other suitable fasteners known in the art. Some examples of mounting structures for mounting a post mount are described in more detail in the above-referenced patents granted to the Applicant. Post mount 12 has an upper end 22 and is elongated between lower and upper ends 20 and 22, having a height H1 extending from upper end 20 to lower end 22.

In accordance with a feature of the invention and with continued reference to FIG. 1, system 10 includes a post insert 24 mounted atop post mount 12 adjacent upper end 22 thereof and distal lower end 20, as will be further detailed below. System 10 may also include outward projections 26 which extend outwardly from post mount 12. System 10 further includes a hollow post 28 having an upper end 29 and a lower end 31 which slides over post insert 24, projections 26, post mount 12 and plate 16. System 10 may include a cap member 30 seated atop post 28. System 10 includes an upper rail structure 32 and a lower rail structure 34 each mounted between a pair of adjacent posts 28. Upper rail structure 32 includes a rail 36 having a first end 38 and a second end 40 opposed thereto with rail 36 being elongated there between. Upper rail structure 32 further includes a rail mounting bracket 42 mounted on each post 28 as necessary to support rail 36 adjacent first end 38 thereof. Another rail mounting bracket 44 is mounted on each post 28 whereby the bracket 44 mounted on an adjacent post 28 supports rail 36 adjacent second end 40 thereof.

Lower rail structure 34 likewise includes a rail 46 having a first end 48 and the second end 50 opposed thereto and being elongated between ends 48 and 50. Lower rail structure 34 also includes a rail mounting bracket 52 mounted on each post 28 for supporting rail 46 adjacent first end 48 thereof. Another rail mounting bracket 54 is mounted on each post 28 opposite a respective rail mounting bracket 52 whereby each rail mounting bracket 54 supports one of rails 46 adjacent respective second end 50 thereof. Lower rail structure 34 is mounted in a conventional manner to a pair of adjacent posts 28.

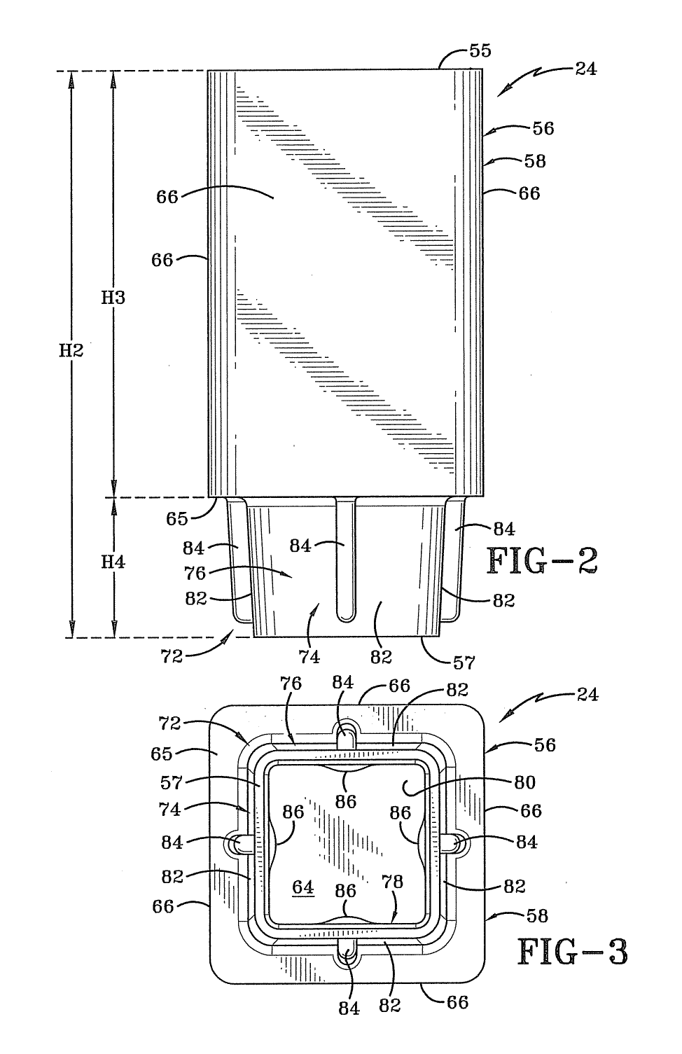

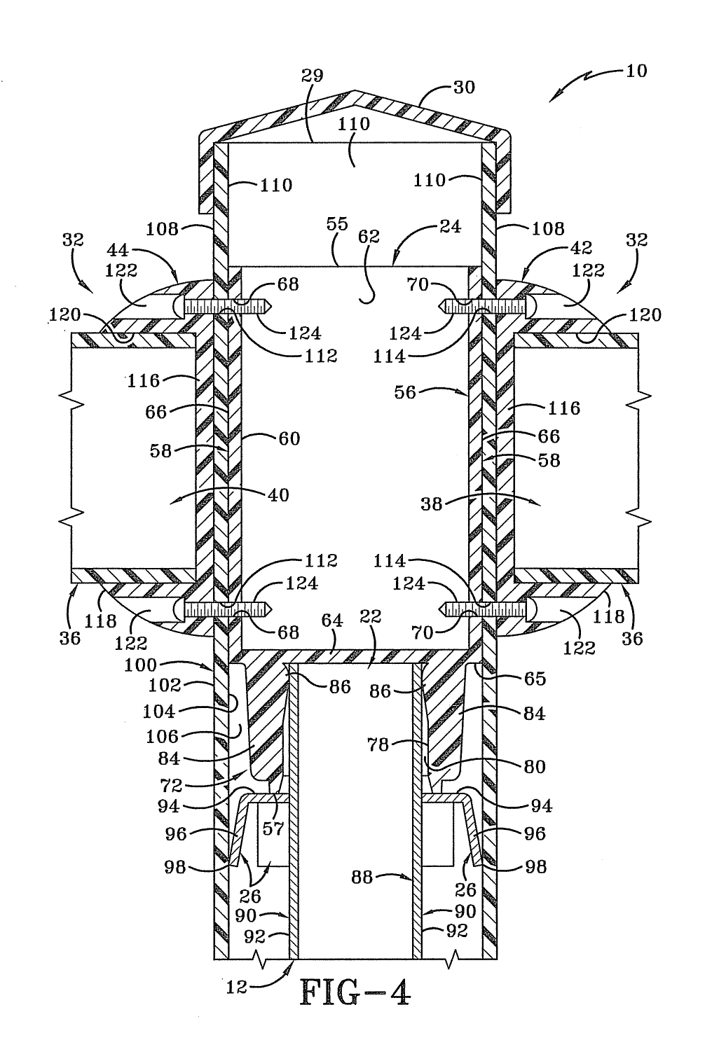

With reference to FIGS. 2-4, post insert 24 is further detailed. Post insert 24 has an upper end 55 and a lower end 57 and is elongated therebetween, with lower end 57 being spaced upwardly a substantial distance (nearly that of height H1) from lower end 20 of post mount 12. Post insert 24 has a height H2 (FIG. 2) extending from upper end 55 to lower end 57. Height H1 (FIG. 1) of post mount 12 is over three times that of height H2 of post insert 24. Post insert 24 includes an upper sleeve or sidewall 56 having an outer surface 58 and an inner surface 60 (FIG. 4) defining an interior chamber or upwardly opening cavity 62. Upper sidewall 56 is substantially square as viewed from above or below although the shape may vary. Preferably however, sidewall 56 is non-circular in cross-section. Upper sidewall 56 extends upwardly from a separating wall 64 (FIG. 4) which serves as a base wall bounding the lower end of cavity 62. Upper sidewall 56 has a lower end 65 coincident with a lower surface of separating wall 64 and a height H3 (FIG. 2) extending from upper end 55 to lower end 65 which is approximately ¾ that of height H2 of post insert 24. Upper sidewall 56 includes four exterior flat portions 66 (FIGS. 2-3). Sidewall 56 defines a pair of holes 68 along one of the flat portions 66 and a second pair of holes 70 along opposed front portion 66 (FIG. 4). Holes 68 and 70 may be threaded if desired.

With continued reference to FIGS. 2-4, post insert 24 further includes a collar 72 extending downwardly from separating wall 64. Collar 72 includes a lower sidewall 74 which is substantially square in cross section and has an outer surface 76 and an inner surface 78 defining an interior chamber or downwardly opening cavity 80. Lower sidewall 74 is stepped inwardly from upper sidewall 56 at lower end 65 of sidewall 56 whereby outer surface 76 of lower sidewall 74 is disposed inwardly of outer surface 58 of upper sidewall 56. Lower sidewall 74 has a height H4 (FIG. 2) extending from lower end 65 of upper sidewall 56 to lower end 57 of post insert 24. Height H3 of upper sidewall 56 is approximately three times that of height H4 of lower sidewall 74. Lower sidewall 74 includes four substantially flat walls 82 with a respective projection or strengthening rib 84 extending outwardly from each flat wall 82 and formed integrally therewith. Each rib 84 extends from adjacent lower end 57 of post insert 24 to separating wall 64 to which rib 84 is connected and with which it is integrally formed. Collar 72 includes four projections 86 each of which extends inwardly from lower sidewall 74 and is integrally formed therewith, each projection 86 defining a portion of inner surface 78 and defining a portion of downwardly opening cavity 80. More particularly, each projection 86 extends inwardly from a respective flat wall 82 of sidewall 74. Projections 86 are disposed adjacent separating wall 64 which bounds an upper end of cavity 80.

With reference to FIG. 4, post mount 12 is further detailed. Post mount 12 is a hollow structure including a sidewall 88 which is substantially square in cross-section and has an outer surface 90. The square cross-sectional configuration provides for four exterior flat portions 92 (only two flat portions 92 are shown in FIG. 4). Post mount 12 adjacent upper end 22 thereof is slidably received within downwardly opening cavity 80 of post insert 24 so that upper end 22 abuts separating wall 64 of post insert 24. Thus, the lower surface of separating wall 64 is disposed a distance equal to height H1 (FIG. 1) from lower end 20 of post mount 12 when post insert 24 is mounted on post mount 12. In addition, outer surface 90 of sidewall 88 of post insert 24 engages inner surface 78 of lower sidewall 74 along projections 86. More particularly, each flat portion 92 of sidewall 88 is in frictional engagement with a respective inward projection 86.

With further reference to FIG. 4, each outward projection 26 mounted on post mount 12 includes an upper substantially horizontal leg 94 which extends outwardly from and is connected to post mount 12 adjacent and spaced downwardly from upper end 22. A tab 96 angles downwardly and outwardly from and is connected to leg 94, each tab 96 having an outermost edge 98. Lower end 57 of post insert 24 is seated atop an upper surface of leg 94 of each outward projection 26.

With continued reference to FIG. 4, post 28 has a sidewall 100 which is substantially square in cross-section and is elongated between upper end 29 and lower end 31 (FIG. 1). Sidewall 100 has an outer surface 102 and an inner surface 104 defining an interior chamber or cavity 106 which opens upwardly adjacent upper end 29 and opens downwardly adjacent lower end 31. Outer surface 102 of sidewall 100 includes four flat exterior surfaces 108, two of which are shown in FIG. 4. Inner surface 104 of sidewall 100 includes four interior flat surfaces 110, three of which are shown in FIG. 4. Sidewall 100 defines a pair of holes 112 extending from one exterior flat surface 108 to a corresponding interior flat surface 110 whereby holes 112 are aligned with respective holes 68 in post insert 24. Sidewall 100 also defines a pair of holes 114 extending from another exterior flat surface 108 to a corresponding interior flat surface 110, the latter of said flat surfaces 108 and 110 being on the opposite side of post 28 from holes 112. Holes 114 are aligned respectively with holes 70 in post insert 24. Holes 68, 70, 112 and 114 are all disposed upwardly of upper end 22 of post mount 12.

When assembled (FIG. 4), post insert 24, post mount 12 and outward projections 26 are slidably received within cavity 106 of post 28. Outermost edges 98 of tabs 96 of projections 26 are in frictional engagement with respective interior flat surfaces 110 of sidewall 100 of post 28. Post insert 24 is positioned within cavity 106 of post 28 so that upper end 55 of post mount 24 is adjacent upper end 29 of post 28. In addition, outer surface 58 of post insert 24 is disposed closely adjacent or in contact with inner surface 104 of post 28. In particular, each flat portion 66 of post insert 24 is closely adjacent or in contact with a respective interior flat surface 110 of post 28. More particularly, outer surface 58 is closely adjacent inner surface 104 of post 28 adjacent upper end 55 and lower end 65 of sidewall 56. Preferably, outer surface 58 of sidewall 56 is in its entirety closely adjacent inner surface 104 of post 28.

With continued reference to FIG. 4, rail mounting bracket 42 includes a base wall 116 and a collar 118 extending outwardly therefrom to define a cavity 120 in which first end 38 of one rail 36 is slidably received with first end 38 closely adjacent or in contact with base wall 116. Collar 118 and base wall 116 of bracket 42 further define a pair of counterbore holes 122 which are aligned with respective holes 114 in post 28 and 70 in post insert 24. A pair of fasteners in the form of threaded screws 124 are each inserted via one of counterbore holes 122 through respective holes 114 and 70, with each screw 124 threadably engaging hole 70 to secure rail mounting bracket 42 to post insert 24 with a portion of sidewall 100 of post 28 sandwiched therebetween, thereby mounting upper rail structure 32 to post 28 and post mount 12.

Thus, in accordance with a feature of the invention, rail mounting bracket 42 is connected to post insert 24 as opposed to being connected solely to post 28, thereby providing a substantially sturdier connection. In addition, because upper sidewall 56 of post insert 24 extends upwardly of upper end 22 of post mount 12, rail mounting bracket 42 is disposed upwardly of upper end 22 of post mount 12. Indeed, bracket 42 is disposed entirely above upper end 22 of post mount 12 whereby first end 38 of rail 36 is also disposed entirely above upper end 22. Since each rail 36 is substantially straight and substantially horizontal, each rail 36 therefore is disposed entirely above upper end 22 of post 12 so that the entire rail structure 32 is disposed entirely above upper end 22 of post 12. Rail mounting bracket 44 has the same configuration as rail mounting bracket 42 or is a mirror image thereof, is numbered similarly and mounted as described with regard to bracket 42. Thus, second end 40 of second rail 36 is received in cavity 120 of mounting bracket 44 with second end 40 disposed closely adjacent or in contact with base wall 116 of bracket 44. Similar to bracket 42, rail mounting bracket 44 is secured to post insert 24 by a pair of threaded screws 124 extending via respective counterbore holes 122 through respective holes 112 and 68 with each screw 124 threadably engaging hole 68. Cap member 30 is seated atop post 28 to protect the hollow interior chamber 106 thereof from the elements and provide preferred aesthetics.

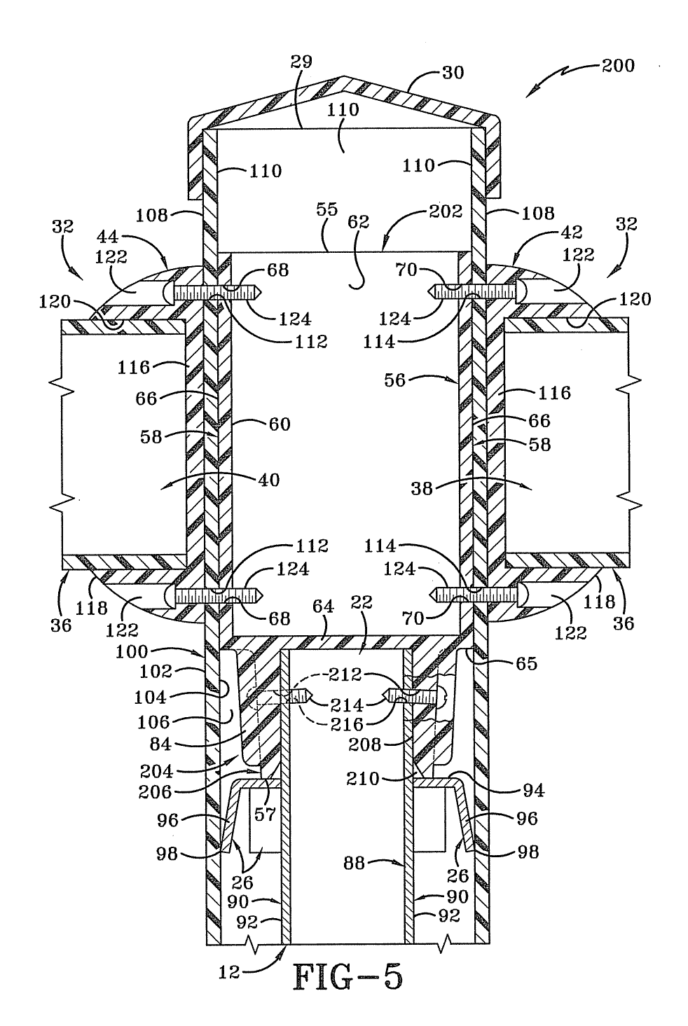

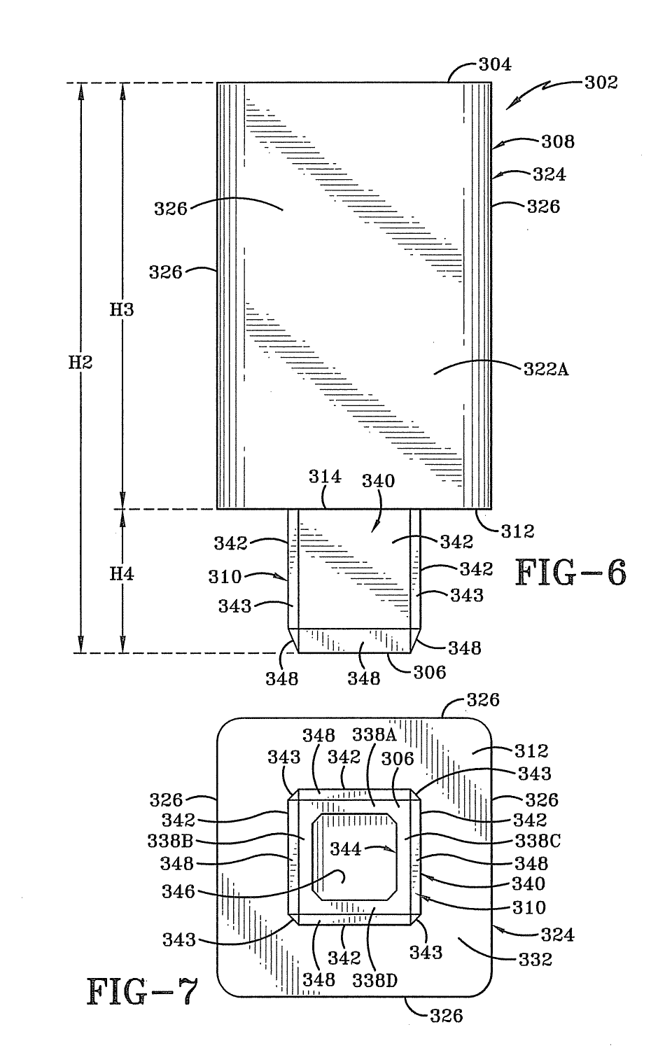

With reference to FIG. 5, fencing system 200 is described. System 200 is similar to system 10 except that it has a post insert 202 which is slightly different than that of post insert 24 of system 10. In particular, post insert 202 is similar to post insert 24 except with regard to a collar 204 which differs from collar 72 of post insert 24. Collar 204 is free of inward projections such as projections 86 of post insert 24. Thus, collar 204 includes a lower sidewall 206 having a substantially square inner surface 208 which is in mating configuration to outer surface 90 of post mount 12 along virtually the entire length of the portion of post mount 12 adjacent upper end 22 thereof which is slidably received within a downwardly opening cavity 210 defined by inner surface 208 of collar 204. In addition, collar 204 defines a plurality of holes as at 212 through which respective fasteners in the form of threaded screws 214 extend and threadably engage holes 216 (which may or may not be threaded) formed in post mount 12 adjacent upper end 22 thereof to further secure post insert 202 to post mount 12. Screws 214 are optional and may be used in the first embodiment as well if desired.

Thus, fencing systems 10 and 200 provide a sturdier mounting system than is known of in the prior art. In particular, post insert 24 provides a sturdier mounting structure to which upper rail structure 32 may be mounted. In particular, post inserts 24 and 202 each provide a structure other than the post itself to which the rail structures or rail mounting brackets are directly secured. Further, outer surface 58 of post insert 24 provides a substantial surface area which is disposed closely adjacent or in contact with inner surface 104 of post 28, thus providing greater stability or sturdiness via a surface area which is larger than in known prior art as well as a substantial area which is closely adjacent or in abutment with the inner surface of the post. Post insert 24 or 202 is also firmly mounted atop post mount 12 as previously described with engagement with post mount 12 and inward projections 86 of post insert 24 or the elongated inner surface 208 of post insert 202. In addition, lower end 57 of post insert 24 or 202 abuts legs 94 of projections 26 to enhance the stable mounting of post inserts 24 and 202. Fasteners such as screws 214 may also increase this stability. Moreover, post mounts 24 and 202 extend primarily is upwardly of upper end 22 of post mount 12, thereby allowing post mount 12 to be shorter while the post mount provides sufficient height for mounting of the rail structure.

It will be evident to one skilled in the art that a variety of changes could be made to present embodiments described which are within the scope of the present invention. For example, as previously mentioned or implied, the cross-sectional shapes of the post, the post insert and the post mount may take on a variety of shapes other than square while still being within the scope of the present invention. As previously noted, preferably these cross-sectional shapes are non-circular in order to facilitate the alignment of the various pieces and related holes and fasteners. In addition, it is preferred that the cross-sectional shape of the outer surface of the post insert upper sidewall is substantially the same as that of the inner surface of the post. It is also preferred that this be the case for the outer surface of the post mount and the inner surface of the lower sidewall of the post insert in the area where they engage one another.

Most typically, post mount 12 is formed of a metal or metal alloy to provide the desired strength, although this may vary for certain applications. Most typically, the post mounts are formed of an extrudable shape to keep costs lower. Similarly, the posts and rails are most preferably formed of extrudable materials and shapes. Most commonly, the rails, rail mounting brackets, post and post insert will be formed of a sturdy plastic material, although again this may vary in accordance with the application.

In addition, rail structures 36 and 46 are shown in the drawings as being formed from more than one piece, namely a rail 36 and rail mounting bracket 42 or 44. Such a configuration allows the rail to be extrudable as previously noted. However, it is contemplated that the rail structure may be a one-piece member which may be formed integrally and has suitable flanges or other structure suitable for mounting to the post insert. Most preferably, the rail structures are mounted to the post insert via fasteners which extend through holes as described and most preferably involve a threaded engagement between the fastener and the post insert. However, other types of suitable fasteners may be used to secure the rail structure to the post insert. For example, fasteners which extend through holes analogous to those described herein and which engage a second fastening member such as a nut may be used. Although this type fastener may require additional effort during assembly, the upwardly opening cavity of the post insert provides access from above to permit the use of these types of fasteners.

In addition, the collars of the post inserts as described herein define a cavity which slidably receives an upper end of the post mount in order to mount the post insert atop the post mount. However, it is contemplated that the first insert may be mounted with a downwardly extended projection which is inserted into the hollow interior of the post mount. However, a collar or similar structure disposed outwardly in the post mount is preferred to provide greater stability. Further, outward projections such as projections 26 which extend from the post mount may be eliminated although they provide additional support to the post insert as well as the post. The specific heights detailed herein may vary. However, the heights which are specified represent typical relationships between various structures of which those heights are given. Other changes within the scope of the invention will be evident to one skilled in the art.

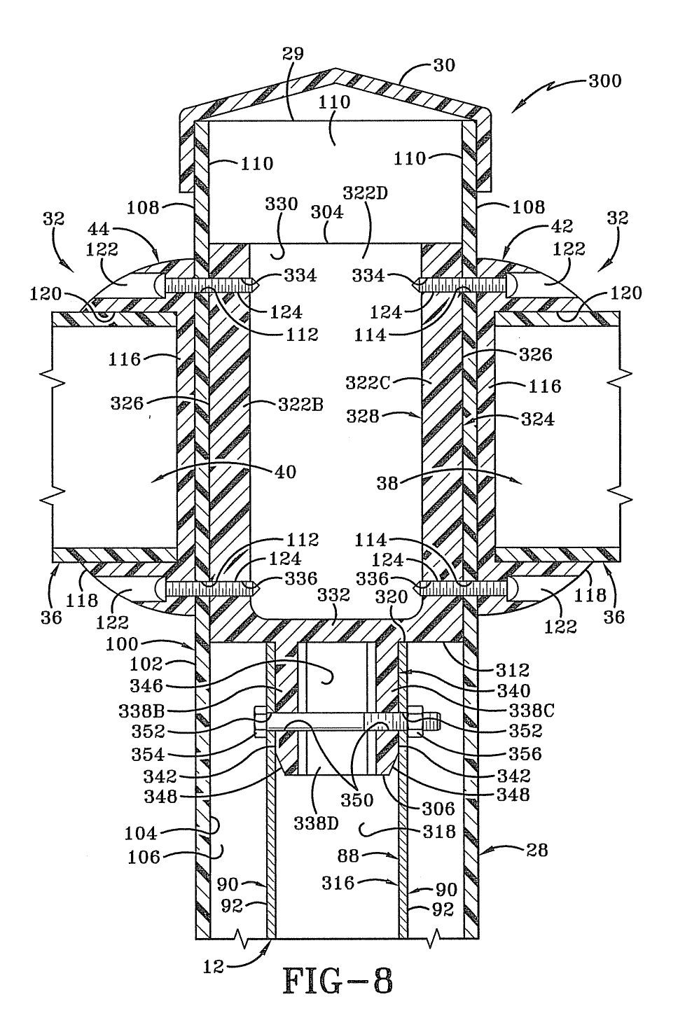

A third embodiment of the post insert is shown generally at 302 in FIG. 6 and in use with a fence system 300 shown in FIG. 8. Post insert 302 is preferably formed as an integral one-piece member which is typically formed of a rigid plastic material which may be formed in a single mold by injection molding or the like. Post insert 302 has upper and lower ends 304 and 306 defining therebetween height H2, as previously discussed with the earlier embodiments, which is preferably greater than or at least as great as the height of mounting brackets 42 and 44. Post insert 302 comprises a body which includes an upper section or sidewall 308 and a lower section or sidewall 310 which extends downwardly therefrom and has a smaller cross-section than that of upper sidewall 308. Upper sidewall 308 has a lower end 312 so that upper end 304 and lower end 312 define therebetween height H3 as discussed with the previous embodiments. Lower sidewall 310 has an upper end 314 coincident with lower end 312 of upper sidewall 308. Upper and lower ends 314 define therebetween height H4 as previously discussed with the earlier embodiments. Lower sidewall 310 has a cross-section substantially smaller than that of the lower sidewalls of the previous embodiments and is configured to be received within an upper end of post mount 12 (FIG. 8). More particularly, post mount 12 has a substantially square inner surface 316 defining an interior chamber or cavity 318 therewithin which communicates with the upper end of is post mount 12 which includes an upwardly facing surface 320.

Upper sidewall 308 has a substantially square cross-sectional configuration as viewed from above or below and includes four substantially flat vertically extending mounting walls 322A-D which are respectively connected to one another at four corners of upper sidewall 308 and collectively form an outer surface 324 thereof. Outer surface 324 on each mounting wall 322 thus includes a respective external flat portion 326. Upper sidewall 308 has an inner surface 328 which defines an upper cavity 330 which opens upwardly at upper end 304 and is closed at the bottom by a laterally extending separating wall 332 which is typically horizontal and from which sidewall 308 extends upwardly. Upper cavity 330 is substantially rectangular as viewed from the side and substantially square as viewed from above.

A pair of upper holes 334 (FIG. 8) are formed respectively in opposed mounting walls 322B and 322C each extending from inner surface 328 to outer surface 324 and respectively aligned with upper holes 112 and 114 formed in post 28. Upper holes 334 are adjacent upper end 304 of post insert 302. A pair of lower holes are formed respectively through walls 322B and 322C adjacent lower end 312 of sidewall 308 and are aligned with respective lower holes 112 and 114 formed in post 28. Holes 334 and 336 are respectively received therein screws 124 to secure mounting brackets 42 and 44 to upper sidewall 308 in a similar manner described in the previous embodiments. Outer surface 324 thus extends upwardly above the upper end of post mount 12 and abuts inner surface 104 of post 28 with flat portions 326 abutting respective flat portions 110. Separating wall 332 serves as a bottom wall extending inwardly from each of mounting walls 322 and preferably extends in a continuous manner between the opposed mounting walls. Separating wall 332 is substantially square and defines horizontal lower surface 312 of upper sidewall 308.

Lower sidewall 310 has a substantially square cross-sectional configuration and is connected centrally to wall 332 and extends downwardly from lower surface 312. The cross-sectional configuration of lower sidewall 310 is substantially smaller than that of upper sidewall 308. Lower sidewall 310 includes four substantially flat vertically extending walls 338A-D which are respectively parallel to mounting walls 322A-D and together define an outer surface 340 of sidewall 310 including four external flat portions or surfaces 342 respectively on walls 338. Outer surface 340 also includes vertically extending beveled corners or surfaces 343 which extend downwardly from surface 312 to adjacent lower end 306 and each of which is typically at an angle of about 45 degrees to each of outer surfaces 342 which it intersects. Beveled surfaces 343 may also be rounded or otherwise shaved to eliminate sharp corners which might otherwise engage post mount 12 to prevent insertion of lower sidewall 310 therein or make it more difficult to insert. Sidewall 310 has an inner surface 344 defining a substantially square lower cavity 346 which is bounded at the top by lower surface 312 of wall 332 and extends and opens downwardly at lower end 306. Lower sidewall 310 tapers inwardly at respective tapered surfaces 348 extending respectively along walls 338A-D such that surfaces 348 communicate with lower end 306. Tapered surfaces 348 facilitate the insertion of lower sidewall 310 into cavity 318 of post mount 12. In the exemplary embodiment, the walls of 338 of lower section 310 have a thickness extending in the horizontal direction which is about the same as the thickness of wall 332 extending in a vertical direction. Walls 322 of upper section 308 are substantially thicker than either of walls 338 or 332 and more particularly in the exemplary embodiment have a thickness extending in the horizontal direction which is approximately twice that of either of walls 332 and 338.

Referring to FIG. 8, a pair of holes 350 are formed respectively through walls 338B and 338C and are aligned with holes 352 formed through post mount 12 adjacent its upper end. Holes 350 and 352 receive therethrough a fastener in the form of a bolt 354 which threadably engages a nut 356 to secure post insert 302 to post mount 12 adjacent its upper end. While such a fastener is preferred for additional security, post insert 302 may be used without such a fastener and simply positioned so that lower surface 312 is seated on upwardly facing surface 320 of post mount 12. Lower surface 312 thus serves as a stop engaging upper surface 320 to prevent downward movement of post insert 302 relative to post mount 12.

Post insert 302 has a body which includes a lower section having an outer surface 340 which extends substantially vertically and abuts vertical inner surface 316 of post mount 12 adjacent its upper end, preferably providing a snug frictional engagement therebetween so that post insert 302 either is not or is only minimally laterally movable relative to post mount 12 even without the use of a fastener. The body of post insert 302 includes a laterally extending downwardly facing surface 312 which extends laterally outwardly from surface 340 to engage upwardly facing surface 320 and in the exemplary embodiment is substantially horizontal. The body of post insert 302 further includes an outer surface 324 which extends upwardly from laterally extending surface 312 and abuts the substantially vertical inner surface 104 of post 28 when received therein. In the exemplary embodiment, first section 308 is disposed entirely above post mount 12. Thus, no portion of post insert 302 is disposed below the upper end 320 of post mount external to post mount 12 and thus no portion of post insert 302 engages outer surface 90 of post mount 12. However, it is contemplated that a post insert may be formed similar to post insert 302 which also incorporates a structure similar to sidewall 74 of post insert 24 (FIG. 2) which is disposed external to post insert 12 and engages its outer surface to provide additional stability.

Fencing system 360 (FIG. 9) is similar to system 10 except that it has posts and post mount assemblies which differ somewhat from those of system 10. Like system 10, system 360 includes rail structures including rails 36 and 46, mounting brackets 42, 44, 52 and 54, and cap member 30. System 360 also includes post mount assemblies 400 and hollow posts 531. As shown in FIG. 9, post mount assemblies 400 are disposed within posts 531 of fencing system 360 to provide a stable brace or support for post 531 and for connecting rails 36 and 46 therebetween. Post mount assembly 400 also includes post mount 12, a post insert 424 and a wedge 497. Post mount 12 was previously described in the description of fencing system 10. In the exemplary embodiment, post mount 12 is a rigid structure formed of a metal, including sidewall 88, which has a substantially square cross-sectional shape as viewed from above. Sidewall 88 has an inner surface including four flat vertical inner surfaces 402 (FIG. 16) of the respective flat walls 90 wherein the inner surface defines an interior chamber or post mount cavity 404 extending from the top of sidewall 88 to the bottom of sidewall 88. As shown in FIGS. 16, 18 and 20, post mount assembly 400 has a central vertical axis X which is at the center of assembly 400 and the center of its main components post mount 12, post insert 424 and wedge 497. Thus, axis X passes through cavity 404 at the center of cavity 404 whereby it is midway between the inner surfaces 402 of the flat walls 92 shown at the left and right in the figures. Axis X is thus also midway between the other flat opposed inner surfaces 402, only one of which is shown in the figures. Similarly, axis X is thus midway between the opposed flat outer surfaces 92 of the walls 90 which are opposed to one another.

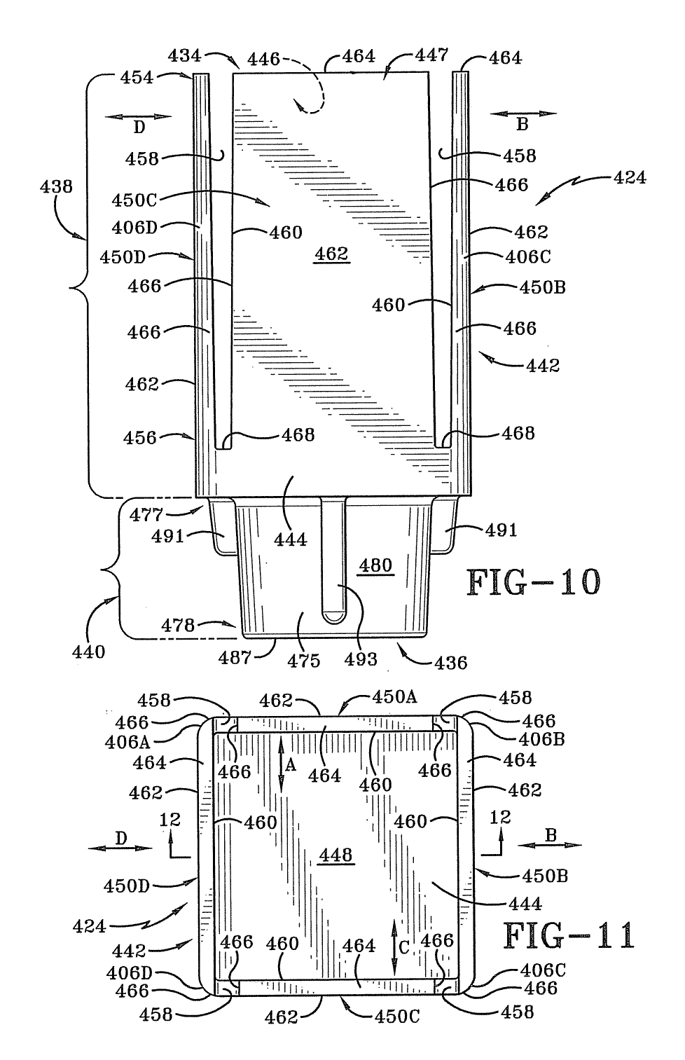

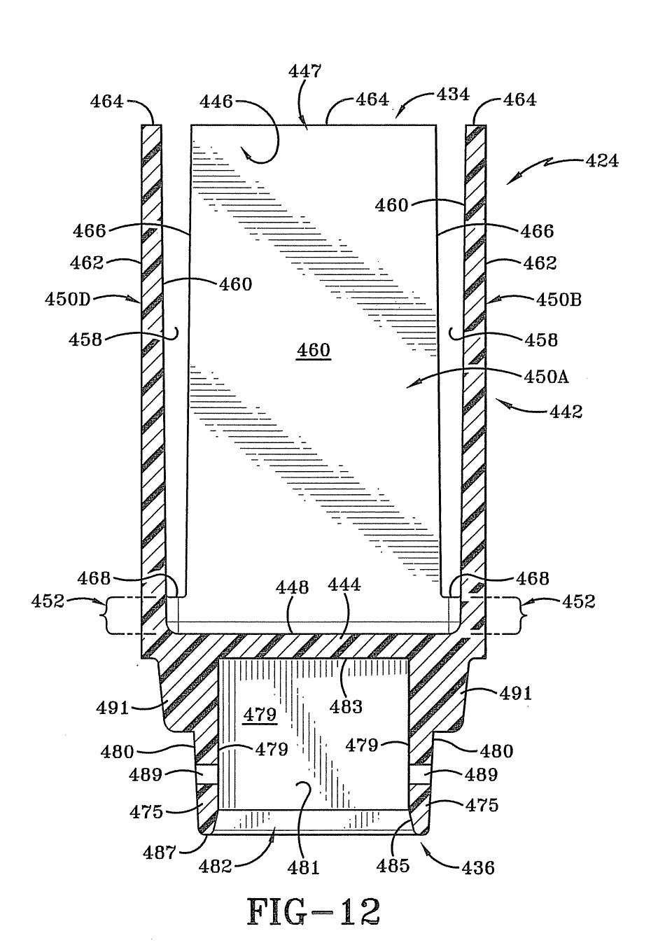

Referring to FIGS. 10-12, post insert 424 is formed of a substantially rigid material as an integral one-piece member, such that all its elements are inherently connected and inseparable. Post insert 424 is typically formed of a plastic material and is molded such as by injection molding or the like. Post insert 424 extends from an upper end 434 to a lower end 436, and is generally comprised of an upper section 438 and a lower section 440 which is rigidly connected to the bottom of upper section 438 and extends downwardly therefrom. Upper section 438 in the exemplary embodiment is substantially square as viewed from above. Upper section 438 includes a sidewall 442 extending upwardly from a laterally extending flat horizontal wall 444 and defining a wedge-receiving post insert or sidewall cavity 446 therein. Wall 444 has a top surface 448 which faces upwardly and defines the bottom of cavity 446. Sidewall 442 is comprised of four substantially flat vertical walls or fingers 450A-D cantilevered upwardly from a bottom section 452. Bottom section 452 is in the exemplary embodiment substantially square as viewed from above, is rigidly secured to the outer perimeter of the square horizontal wall 444 and extends upwardly from top surface 448 thereof, and extends in a continuous fashion around the bottom portion of cavity 446. Thus, the inner surface of bottom section 442 defines the bottom section of cavity 446 extending upwardly from top surface 448. Bottom section 452 includes four flat wall sections which are secured at respective corners to form the square shape as viewed from above. Each finger 450 has a lower end 456 which is rigidly secured to the top of a respective flat wall section of bottom section 452 such that each finger is an upward continuation of the respective flat wall section of bottom section 452 whereby the inner surfaces of the given finger and associated flat wall section are coplanar, and the outer surfaces of the finger and corresponding flat wall section are likewise coplanar. Each finger 450 extends upwardly from lower end 456 to a terminal free upper end 454. Fingers 450 are spaced apart by a substantially vertical spacer notch 458 defined between each finger 450. Each finger 450 has a substantially vertical inner surface 460 which faces and bounds cavity 446 and serves as a cam surface, an opposed substantially vertical outer surface 462 which faces away from cavity 446 and serves as a post-engaging surface, a top upwardly facing narrow surface or edge 464 which serves as an uppermost surface of the respective finger and of post insert 424, and a pair of narrow substantially vertical side surfaces or edges 466. As best seen in FIG. 11, the edges 466 of fingers 450B and 450D are adjacent or coincident with four vertical corners 406A-D of sidewall 442 wherein said corners extend vertically from the top 464 of fingers 450 and of upper section 438 to the bottom of upper section 438 and the bottom of horizontal wall 444. Thus, notches 458 are respectively adjacent corners 406A-D. One of notches 458 is more particularly defined between one of edges 466 of finger 450A and the inner surface 460 of finger 450D adjacent its edge 466 adjacent corner 406A. Another of notches 458 is defined between the other edge 466 of finger 450A and the inner surface 460 of finger 450B adjacent its edge 466 adjacent corner 406B. Another of notches 458 is defined between one of edges 466 of finger 450C and inner surface 460 of finger 450B adjacent its opposed edge 466 adjacent corner 406C. The fourth notch 458 is defined between the other edge 466 of finger 450C and the inner surface 460 of finger 450D adjacent its edge 466 adjacent corner 406D.

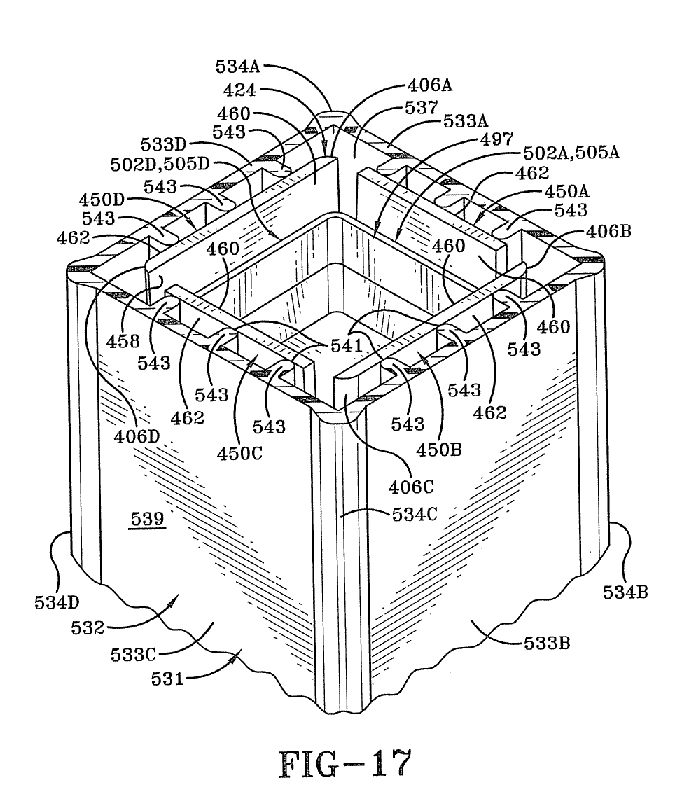

An upwardly facing horizontal notch surface 468 extends parallel to and upwardly of top surface 448 of horizontal wall 444 and defines the bottom of the respective notch 458. Each surface 468 extends from the bottom of one of edges 466 one of fingers 450 to the adjacent inner surface 460 of the adjacent finger 450 near the respective corner. Surfaces 468 define the top of bottom section 452 of sidewall 442 and the bottom of fingers 450. Each finger 450 is formed so as to be flexible about lower end 456 whereby fingers 450 flex between a first position (FIGS. 10-13, 15 and 16) and a second position (FIGS. 17-20). The first position is the default position or home position in which finger 450 is at rest and is substantially vertical. Fingers 450 are typically formed of a resilient plastic material which allows the fingers to flex back and forth to move in the respective directions shown by Arrows A, B, C, and D in FIGS. 10 and 11. Fingers 450 will remain in their home position at rest absent an inward or outward force, which would respectively cause the upper ends 464 to move inwardly and outwardly in the directions shown respectively by Arrows A, B, C and D. The resilient nature of each finger will cause it to flex back to its home position from the second position or from a position in which it was flexed inwardly when the force is removed which caused it to move away from the home position.

Lower section 440 of post insert 424 is similar to collar or lower section 204 of post insert 202 (FIG. 5) and includes many of the general features discussed previously. Lower section 440 has an upper end 477 rigidly secured to and extending downwardly from the bottom of upper section 438 and a lower end 478 coincident with lower end 436 of post insert 424. Lower section 440 is configured to receive upper end 22 of post mount 12 (FIG. 16). Lower section 440 comprises a lower sidewall 475 which is rigidly secured to and extends downwardly from the bottom of horizontal wall 444 to lower end 478. Lower sidewall 475 further includes a substantially vertical outer surface 480 and a substantially vertical inner surface 479 which defines a lower cavity 481 which is substantially square as viewed from below. Lower cavity 481 is bounded at the top by a downwardly facing lower surface 483 of wall 444 and extends downwardly therefrom to open downwardly at a bottom entrance opening 482 at lower end 478 to receive upper end 22 of post mount 12 therein. Inner surface 479 includes a beveled guide edge 485 which terminates into a bottom surface 487 for easier insertion of post mount 12 into lower cavity 481. Lower sidewall 475 defines a pair of fastener holes 489 extending from inner surface 479 to outer surface 480. As shown in FIG. 10, a pair of shorter opposed brace ribs 491 are rigidly secured to and extend downward vertically from lower surface 483 of wall 444 and terminate generally at the midpoint of lower section 440 proximate and above each fastener hole 489. Shorter ribs 491 also are rigidly secured to and extend outwardly from the respective outer surfaces 480 of the two flat walls of sidewall 475 which define holes 489 respectively. A pair of taller opposed brace ribs 493 are rigidly secured to and extend downward vertically from lower surface 483 and terminate proximate lower end 478 of lower section 440. Taller ribs 493 are also rigidly secured to and extend outwardly from the respective outer surfaces 480 of the flat walls of sidewall 475 which do not define holes 489. Shorter ribs 491 thus extend in opposite directions from one another and taller ribs 493 likewise extend in opposite directions from one another and perpendicular to shorter ribs 491.

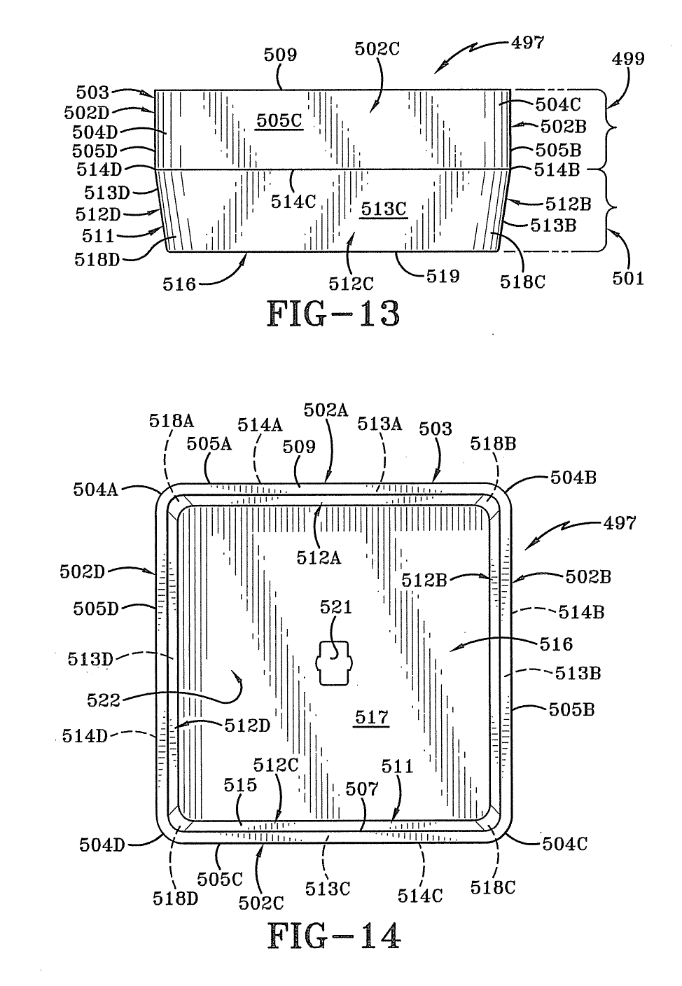

Referring to FIGS. 13 and 14, expander wedge 497 is a rigid component which is typically formed of a rigid plastic material and molded such as by injection molding whereby expander wedge 497 is typically formed as an integral one piece member. Wedge 497 has a generally square cross-sectional shape as viewed from above and includes an upper section 499 and a lower section 501. Upper section 499 is comprised of an upper sidewall 503 formed from four connected flat vertical walls 502A-D rigidly secured at respective vertical corners 504A-D whereby sidewall 503 has a generally square cross-sectional shape as viewed from above. Sidewall 503 includes a smooth substantially square vertical outer surface 505, a substantially square vertical inner surface 507, and a substantially square horizontal top narrow upwardly facing surface or edge 509. More particularly, outer surface 505 includes four smooth flat vertical outer surfaces 505A-D of the flat vertical walls 502A-D of sidewall 503 whereby outer surfaces 505A and 505C are parallel and face away from one another while outer surfaces 505B and 505D are parallel and face away from one another and are perpendicular to surfaces 505A and 505C.

Lower section 501 includes an angled or tapered sidewall 511 which is rigidly secured to and extends downwardly from the bottom of wall 503. More particularly, tapered wall 511 has the shape of an inverted right rectangular pyramid which extends downwardly from the bottom of wall 503 and is truncated at bottom wall 516. Tapered sidewall 511 in the exemplary embodiment has a square cross-sectional shape as viewed from above and includes four flat tapered walls 512A-D which are rigidly secured respectively to the flat vertical walls 502A-D of sidewall 503 and extend downwardly therefrom. Tapered walls 512A-D are rigidly secured to one another at four tapered corners 518A-D. Thus, tapered wall 511 may be described as tapering downwardly and inwardly from the bottom of sidewall 503 to bottom wall 516, or alternately as tapering upwardly and outwardly from bottom wall 516 to the bottom of sidewall 503. Flat walls 512A-D thus taper downwardly and inwardly with respect to the associated vertical walls 502A-D.

Tapered sidewall 511 has an outer surface 513 and an inner surface 515 each extending downwardly from the bottom of sidewall 503 and terminating into square flat horizontal bottom wall 516. Outer surface 513 serves as a cam surface and tapers upwardly and outwardly from a downwardly facing bottom surface 519 to the bottom of outer surface 505 at a square horizontal intersection 514 therebetween. Outer surface 513 more particularly includes four flat outer surfaces 513A-D respectively of flat tapered walls 512A-D wherein each of outer surfaces 513A-D tapers downwardly and inwardly respectively from outer surfaces 505A-D of sidewall 503. Square horizontal intersection 514 thus includes four straight horizontal intersections 514A-D wherein the bottom of outer surface 505A intersects the top of outer surface 513A at intersection 514A, the bottom of outer surface 505B intersects the top of outer surface 513B at intersection 514B, the bottom of outer surface 505C intersects the top of outer surface 513C at intersection 514C, and the bottom of outer surface 505D intersects the top of outer surface 513D at intersection 514D. Each of tapered corners 518A-D tapers downwardly and inwardly from the bottom of corners 504A-D respectively. Thus, outer surface 513 of tapered is wall 511 tapers as described when viewed from the side in any direction when wedge 497 is in the upright position shown in FIG. 13 so that when viewed from the side in a given direction, outer surface 513 at its bottom is narrower as measured horizontally than is outer surface 513 at or adjacent its top, intersection 514 and outer surface 505. Bottom wall 516 includes a square flat horizontal upwardly facing top surface 517, square flat horizontal downwardly facing bottom surface 519, and defines a central keyhole 521 extending therethrough from bottom surface 519 to top surface 517.

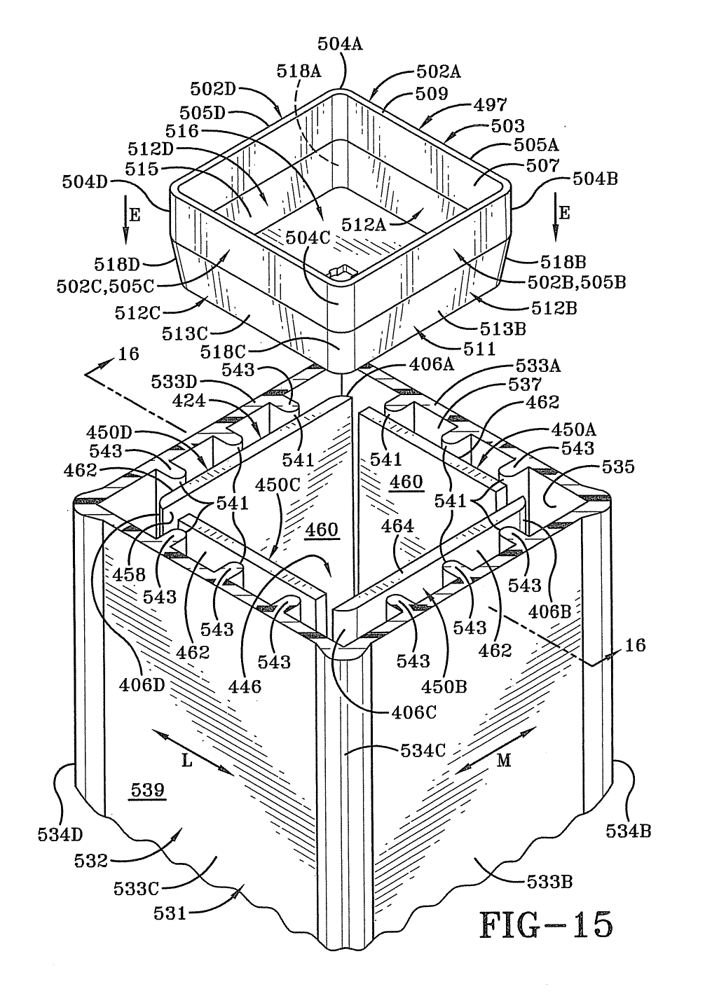

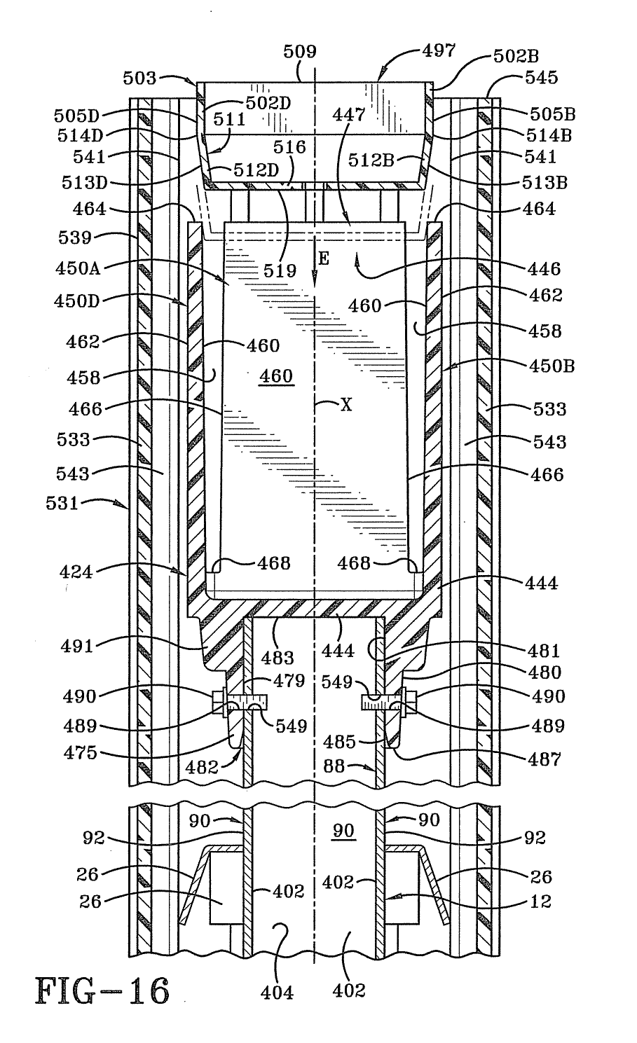

Referring to FIGS. 9 and 15, post mount assembly 400 is slidably received in post 531 which in the exemplary embodiment is formed as an extruded integral one-piece member. As an extruded component, post 531 thus has a cross section which is constant from its top to its bottom. Post 531 is hollow and has an upper end or top 545, a lower end or bottom 547, and a sidewall 532 extending from top 545 to bottom 547 and having a generally square cross-sectional shape forming therewithin a post cavity 535. Sidewall 532 includes four flat vertical walls 533A-D which are rigidly secured at four respective vertical corners 534A-D. Each flat wall 533 further includes a flat vertical inner surface 537 which extends from top 545 to bottom 547 and forms part of an inner surface of hollow post 531 and thus partially defines cavity 535. Each wall 533 also has a flat vertical outer surface 539 which faces away from cavity 535 and which extends from top 545 to bottom 547, which serve respectively as the top and bottom of wall 533 and sidewall 532. A plurality of vertical strengthening ribs 543 are rigidly secured to and extend inwardly and generally perpendicularly from each inner surface 537 to vertical terminal tips 541 whereby ribs 543 also serve as part of the inner surface of post 531 so that inner surface 537 and ribs 543 together define post cavity 535. Strengthening ribs 543 extend continuously from upper end 545 to lower end 547 (FIG. 9) of post 531. In the exemplary embodiment, a set of three of the ribs 543 are secured to and extend inwardly from each of sidewalls 533A-D. The three ribs in each set are horizontally spaced from one another and from the two flat walls 533 which are secured to and extend perpendicular to the wall 533 to which a given set of three ribs 543 are secured. Thus, the three ribs 543 attached to wall 533A and the three ribs 543 attached to wall 533C extend toward one another such that the tips 541 of one set face the tips 541 of the opposed set. The three ribs secured to wall 533B and the three ribs secured to wall 533D have the same relationship to one another and extend horizontally inwardly perpendicular to the ribs on walls 533A and 533C.

The assembly and operation of fencing system 10 is now described with reference to FIGS. 9 and 15-20. As shown in FIG. 9 and discussed previously with reference to system 10, a user rigidly secures lower end 20 of post mount 12 to foundation 14 with upper end 22 extending upwardly to fix post mount 12 in a substantially vertical orientation perpendicular to the typically horizontal upper surface of foundation 14. Post insert 424 is secured to upper end 22 of post mount 12 by way of a pair of fasteners 490, either before or after post mount 12 is secured to foundation 14. As shown in FIGS. 16, 18 and 20, fasteners 490 extend through outer surface 480 of lower sidewall 475 into the respective fastener hole 489, and extend out through inner surface 479 and into post mount 12 respectively through a pair of mounting holes 549 formed in post mount 12 and aligned with holes 489. Fasteners 490 thereby rigidly secure post insert 424 via collar 440 to upper end 22 of post mount 12.

After post mount 12 is secured to foundation 14, and post insert 424 is secured to upper end 22 of post mount 12, the user then slides post 531 (FIG. 9) downwardly over post insert 424 and post mount 12, which are slidably received in cavity 535 so that lower end 547 of post 531 is seated on the upper surface of foundation 14 proximate lower end 20 of post mount 12 and so that upper end 545 of post 531 is positioned above and proximate upper end 434 of post insert 424. Lower plate 16 (FIG. 9) is thus received in the lowermost portion of post cavity 535 such that the flat vertical outer surfaces forming the outer perimeter of plate 16 are adjacent or abutting the respective set of three ribs 543 extending inwardly from the respective flat walls 533A-D of post 531. As shown in FIGS. 15-16, fingers 450A-D are substantially parallel respectively to sidewalls 533A-D of post 531 when fingers 450 are at rest in the home position and within cavity 535. In the home position of fingers 450, each outer surface 462 of the respective finger 450 faces and is adjacent the tips 541 of one of the set of three ribs 543 extending inwardly from a given one of walls 543A-D. FIGS. 15 and 16 also illustrate that there is a small gap as measured horizontally between the outer surface 462 of a given finger 450 and the corresponding tips 541 of the associated ribs 543. As a result, post 531 adjacent its upper end at the height of post insert 424 is able to move horizontally back and forth in any horizontal direction, which is illustrated by Arrows L and M in FIG. 15. In the home position, the outer surface 462 of a given finger 450 is thus typically out of contact with the tips 541 which it faces and thus typically out of contact with the inner surface of post 531 whereby post insert 424 may be completely out of contact with the inner surface of post 531 when received therein and prior to the insertion of wedge 497 as detailed further below. Post insert 424 is sized such that each outer surface 462 is closer to each corresponding inner surface 537 and set of tips 541 facing the given outer surface 462 than is the corresponding outer surface 92 of post mount 12 as measured horizontally between the respective surfaces.

Before providing additional description of the assembly and operation of fencing assembly 400, additional structural relationships are discussed. As previously noted, axis X serves as the central vertical axis for post insert 424. Axis X is thus midway between vertical corners 406A and 406C as well as midway between vertical corners 406B and 406D. Axis X is likewise between the opposed and substantially parallel inner surfaces of opposed fingers 450A and 450C, said surfaces 460 facing one another. Axis X is also midway between the outer surfaces 462 of said fingers 450A and 450C. Similarly, axis X is midway between the inner surfaces 460 of fingers 450B and 450D, as well as midway between the outer surfaces 462 of fingers 450B and 450D. Axis X passes through the center of post insert cavity 446 and lower cavity 481.

As previously noted, vertical axis X serves as the central vertical axis of wedge 497 and thus passes through the center of keyhole 521 and a wedge cavity 522 defined by sidewalls 503 and 511 and bottom wall 516. Axis X is thus centered or midway between corners 504A and 504C, as well as midway between corners 504B and 504D. Axis X is midway between the vertical inner surfaces of walls 502A and 502C, as well as midway between the vertical inner surfaces of walls 502B and 502D. Axis X is thus also midway between the outer surfaces of walls 502A and 502C, as well as midway between the outer surfaces of walls 502B and 502D.

When post 531 is slid over post mount assembly 400 so that assembly 400 is received within cavity 535, vertical axis X also serves as the central vertical axis of post 531. Axis X is thus midway between corners 534A and 534C, as well as midway between corners 534B and 534D. Axis X is also midway between inner surfaces 537 of opposed walls 533A and 533C, as well as midway between the inner surfaces 537 of walls 533B and 533D. Axis X is thus also midway between outer surfaces 539 of opposed walls 533A and 533C, as well as midway between outer surfaces 539 of walls 533B and 533D.

When post mount assembly 400 is disposed in post cavity 535 and with reference to FIGS. 9,16,18 and 20, the outer tips or edges of projections 26 engage tips 541 of ribs 543 in the same manner as described with the use of post mount 12 in fencing system 10 other than the fact that projections 26 are engaging the tips of the ribs in system 400 whereas projections 26 engage the flat inner surfaces of post 28 in system 10. In addition, the projections 26 in system 400 are positioned at a height adjacent the height of lower rails 46 in system 400 to provide additional strength for the mounting of lower mounting brackets 52 and 54 whereas projections 26 in system 10 are at a height just below the post insert 24 thereof and closer to the upper mounting brackets 42 and 44. When post mount assembly 400 is disposed in post cavity 535, corners 406A-D of post insert 424 are respectively adjacent and inward of corners 534A-D of post 531.

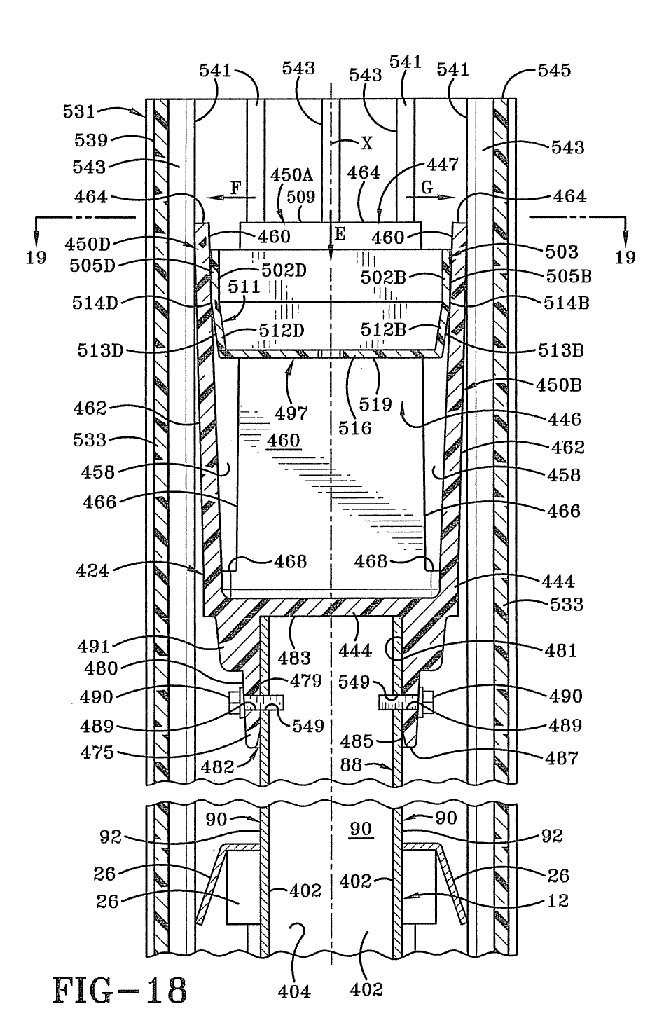

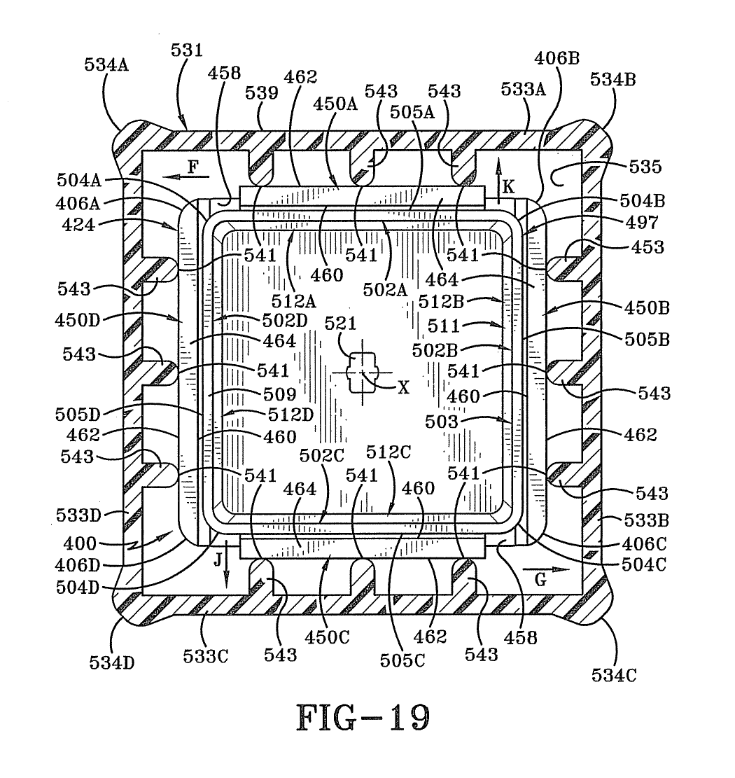

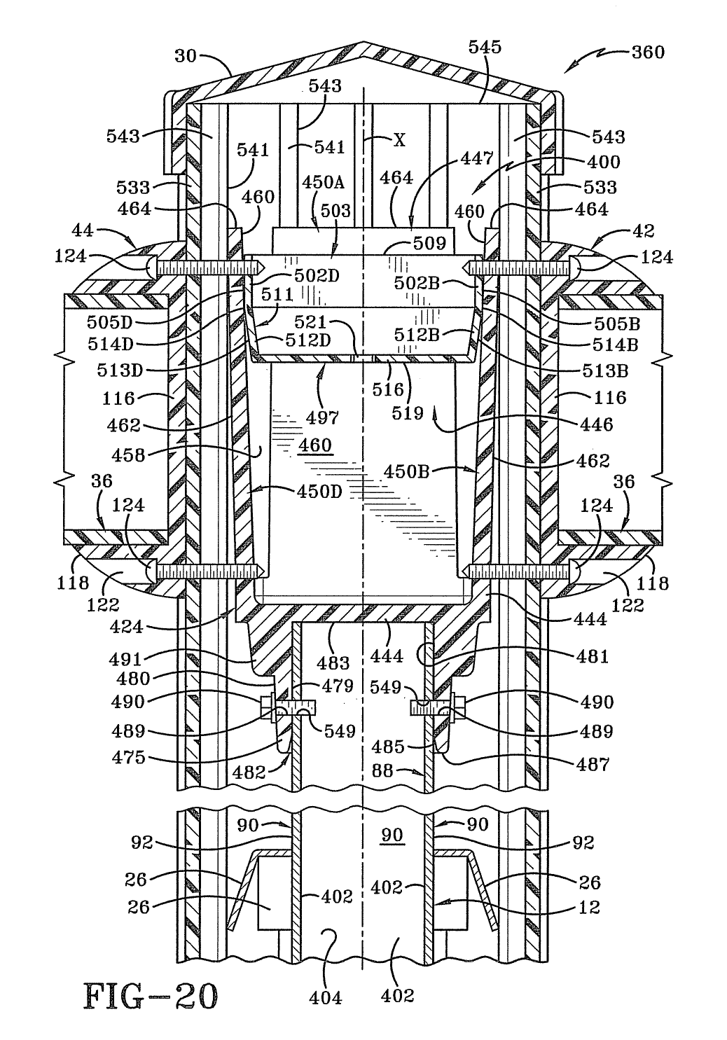

To flex fingers 450 from the first or home position (FIG. 16) to the second or contact position (FIG. 18), the user forcibly inserts expander wedge 497 into post insert cavity 446. As shown in FIGS. 15-18, expander wedge 497 is moved vertically downwardly (Arrows E) into cavity 446 so that expander wedge 497 pushes fingers 450 in the directions of Arrows F, G, J and K (FIGS. 18-19). Wedge 497 is thus initially at a position external to and above post cavity 535 and post insert cavity 446 entirely above top 545 of post 531, and moves downwardly therefrom through the top entrance opening of post cavity 535 at top or upper end 545 into the upper portion of post cavity 535 before contacting fingers 450 of post insert 424 and entering post insert cavity 446. More particularly, a downward force also illustrated by Arrows E is applied to wedge 497 in order to move wedge 497 vertically downward in a linear fashion while wedge 497 remains in an upright orientation from a first position shown in FIG. 15 and in solid lines in FIG. 16 in which wedge 497 is out of contact with post insert 424 and post 531 (as well as with all other components of system 360) to an intermediate position shown in dashed lines in FIG. 16 in which the tapered outer cam surfaces 513A-D are respectively in contact with inner surfaces 460 of fingers 450A-D at or adjacent their respective intersections with upper surfaces 464 of the respective fingers. Wedge 497 thus enters post insert cavity 446 through top entrance opening 447 as illustrated at the position shown in dashed lines in FIG. 16 with bottom wall 516 and the narrowest portion of tapered wall 511 entering cavity 446 first with the remainder of wedge 497 following. As wedge 497 continues its vertically downward movement, surfaces 513A-D slidably engage the respective inner surfaces 460 at or adjacent the above noted intersections in order to cause the respective fingers 450A-D to move radially outwardly away from vertical central axis X. More particularly, upper ends 454 of fingers move outwardly away from axis X during the flexing of the fingers so that the respective outer surfaces 462 of fingers 450A-D move into contact with tips 541 of the ribs 543 on the respective walls 533A-D of sidewall 532 of post 531. As wedge 497 is pushed or forced vertically downwardly further, it moves from the intermediate position shown in dashed lines in FIG. 16 to the final wedged position shown in FIG. 20. During this continued downward movement of wedge 497, the respective intersections 514A-D and/or the outer surfaces 505A-D of wall 503 slidably engage the respective inner surfaces 460 of the respective fingers 450A-D.

Thus, the outer surfaces 513, intersections 514 and/or outer surfaces 505 serve as cam surfaces which slidably engage the respective inner surfaces 460 so that the vertically downward movement of wedge 497 is translated into the radially outward movement of the upper ends 454 of the respective fingers 450 away from axis X. In the exemplary embodiment, the movement of upper ends 454 of fingers 450 is substantially horizontal between the first and second positions. The downward force on wedge 497 is thus translated into a radially outward forces on fingers 450, said radially outward forces detailed below. Once wedge 497 is in its wedged position shown in FIGS. 19 and 20, the outer surfaces 505, and/or intersections 514 apply respective radially outward forces away from axis X in a substantially horizontal direction (also represented by arrows F, G, J and K) on the respective inner surfaces 460 of the fingers 450 so that said radially outward forces are transferred respectively through fingers 450A-D to ribs 543 and walls 533A-D via the frictional engagement between outer surfaces 462 and tips 541 of ribs 543. In response to the insertion of expander wedge 497 into post insert cavity 446, the upper ends 454 of fingers thus move pivotally into contact with the inner surface of post 531 while lower ends 456 remain substantially fixed.

Referring to FIG. 19, finger 450A moves in the direction of Arrow K, which is different from the directions in which the other fingers 450B-D move when wedge 497 is inserted into cavity 446. Finger 450A moves in a direction which is opposite the direction which finger 450C moves (Arrow J), and transverse and more particularly perpendicular to the direction which fingers 450B and 450D move (Arrows G and F, respectively). Finger 450C thus moves transverse and more particularly perpendicular to the direction which fingers 450B and 450D move. Fingers 450B and 450D move in directions opposite one another and transverse to and more particularly perpendicular to the direction in which fingers 450A and 450C move. As shown in FIG. 9, the abutment of fingers 450 with strengthening ribs 543 frictionally secures post insert 424 to post 531. The abutment also adds overall stability to fencing system 10, particularly where rail mounting bracket 42 is mounted to post 531 to provide support for upper rail structure 32. The frictional engagement between the outer surface of wedge 497 and the inner surfaces 460 of fingers 450 is the only connection required to keep or secure wedge 497 in the wedged position, and in the exemplary embodiment is the only connection for that purpose. The friction between outer surfaces 462 of fingers 450 and the inner surface of post 531 provided by tips 541 of ribs 543 holds post 531 firmly in place unless and until expander wedge 497 is moved upwardly sufficiently to allow fingers 450 to move inwardly away from and typically out of contact with ribs 543.

In the wedged position in the exemplary embodiment, bottom wall 516, tapered wall 511 and sidewall 503 are all disposed entirely within post insert cavity 446 whereby wedge 497 is entirely within post insert cavity 446 below the top or upper ends 446 of the fingers 450 and post insert 424. In the wedged position, wedge 497 is in its entirety lower than upper end 464 and spaced upwardly from and out of contact with horizontal wall 444. In the exemplary embodiment in the wedged position, no portion of wedge 497 extends radially outwardly relative to axis X beyond inner surfaces 460 of fingers 450 or the generally vertical planes in which inner surfaces 460 lie, nor beyond outer surfaces 462 of fingers 450 nor the generally vertical planes in which surfaces is 462 lie. Similarly, in the exemplary embodiment, wedge 497 in the wedged position is entirely within post cavity 535 adjacent and spaced downwardly from top 545 of post 531 whereby no portion of wedge 497 extends radially outwardly beyond the inner or outer surfaces of post 531. Similarly, post assembly 400 in its entirety is exposed within post cavity 535 such that no portion of assembly 400 extend radially and outwardly beyond the inner or outer surfaces of post 531 in the exemplary embodiment.

Fingers 450 may be moved from the second position (FIGS. 18-20) to the first position (FIG. 16) by removing expander wedge 497 from post insert cavity 446 of post insert 424, thereby allowing the retracting of fingers 450 from strengthening ribs 543 due to the resilient nature of fingers 450. Inasmuch as expander wedge 497 is tightly frictionally engaged with inner surfaces 460 of fingers 450 and wedge 497 does not provide surfaces which may be easily manually grasped in the wedged position, a tool (not shown) is typically used to remove expander wedge 497. The tool is inserted downwardly through keyhole 521 and is rotated about axis X to engage the bottom surface of bottom wall 516. The user then pulls the tool upwardly away from post insert 424 which in turn pulls expander wedge 497 upwardly out of post insert cavity 446. While the exemplary embodiment of expander wedge 497 includes keyhole 521, other structures and methods for extraction of expander wedge 497 may be used, including altering the form of expander wedge 497 to include a manual handle or other means for extraction.

After wedge 497 has been moved to the wedged position to secure the upper end of post 531, cap member 30 is slid over the top of post 531, which is received within the cavity defined by cap member 30. In addition, the rail structures may be secured to posts 531 adjacent its upper end in the vicinity of post insert 424 as illustrated in FIGS. 9 and 20. As discussed with fencing system 10, the respective mounting brackets are secured to post 531 with the corresponding rails inserted into the mounting brackets. In the exemplary embodiment illustrated in FIG. 20, screws 124 are used to secure the mounting brackets 42 and 44 to the corresponding flat walls 533 of post 531. In the exemplary embodiment, each screw 124 extends through and from a hole formed in one of brackets 42 and 44 into a hole formed in one of sidewalls 533 and threadedly engages the wall 533 within said hole. In the exemplary embodiment, each of screws 124 extends inwardly beyond tips 541 of ribs 543 and through a hole formed in one of walls 450. Thus, screws 124 have respective tips which are inward of tips 541 of ribs 543 and walls 450 within the post cavity and wedge-receiving cavity 446. Each of screws 124 threadedly engages a respective wall 450 of post insert 424. Each of screws 124 extends from and through a portion of wall brackets 42 and 44 to and through one of walls 533 of the post and from said wall 533 to and through a corresponding wall 450. The lower screws 124 engage and extend through the corresponding wall 450 adjacent its lower end while the upper screws 124 engage and extend through the corresponding wall 450 adjacent its upper end. The upper screws 124 also extend from the corresponding wall 450 to and through one of side walls 503 and 511 of wedge 497 such that the tips of the upper screws 124 are inwardly of side walls 503 and 511 within the wedge cavity of wedge 497. Thus, each of screws 124 secures a respective bracket 42 or 44 to the walls 533 of a post and one of walls 450 of the post insert 424 while the upper screws 124 also secure the corresponding bracket, wall 533 of the post, wall 450 and the side wall of wedge 497 to one another whereby each of these components is fixed relative to one another when the fencing system is assembled.

The lower mounting brackets 52 and 54 (FIG. 9) are likewise secured to post 531 with similar screws. Unlike system 10, system 360 provides the projections 26 at about the same height as the lower rails 46 to provide additional support for connecting the lower rail structures to post 531. In addition, the use of strengthening ribs 543 from the top to the bottom of post 531 provides additional structural support in the region of the mounting of the lower mounting brackets and rails.

The wedging apparatus and method of the present invention creates a “universal fit” between a given size of post insert 424 and expander wedge 497, and varying cross-sectional sizes of post 531. As shown in FIG. 18, post 531 has a particular cross-sectional size. However, post insert 424 may be used with differing posts 531 having larger or smaller cross-sectional sizes. To accommodate posts 531 having a larger cross-sectional size, the user simply plunges expander wedge 497 deeper into post insert cavity 446 until fingers 450 flex outwardly a sufficient amount to abut strengthening ribs 543. Conversely, to accommodate post 531 having a smaller cross-sectional size, the user accordingly plunges expander wedge 497 to a shallower position within post insert cavity 446. Manufacturing and construction efficiency is significantly increased from using a standard size post insert 424 and expander wedge 497 to brace differently sized posts 531. In contrast, known prior art post inserts are manufactured to fit only with a particular post having a specific cross-sectional area.

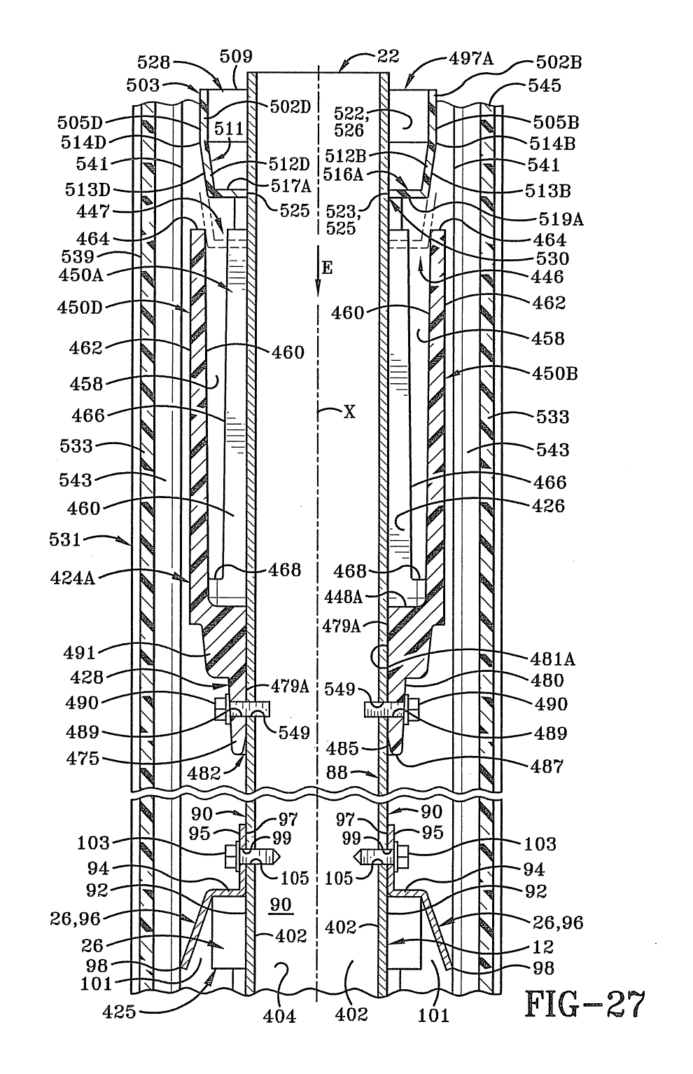

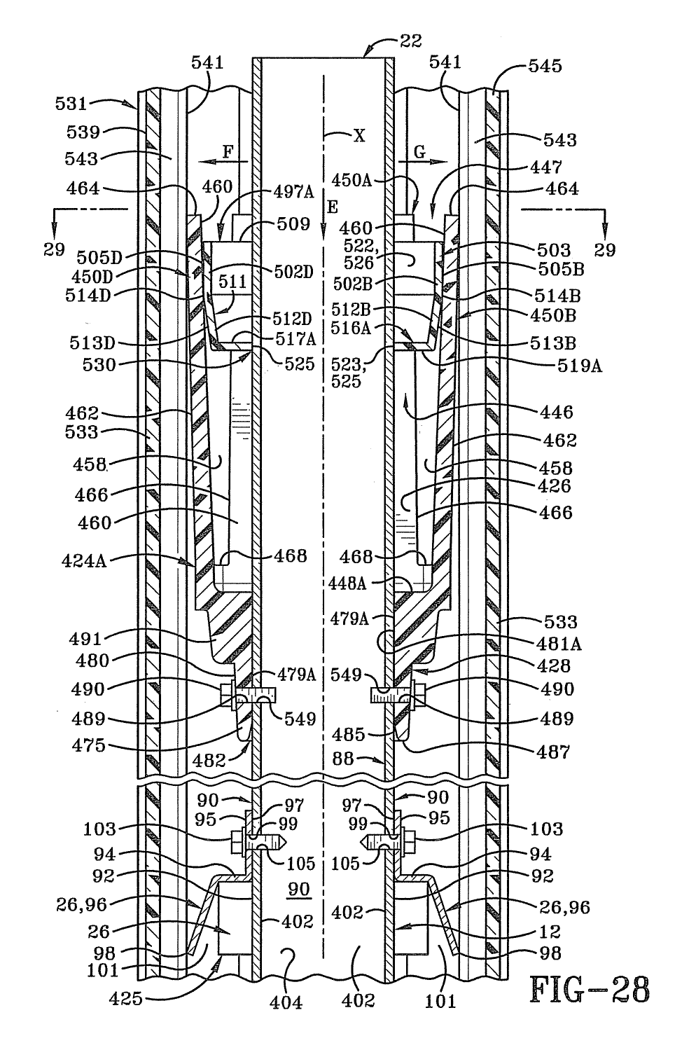

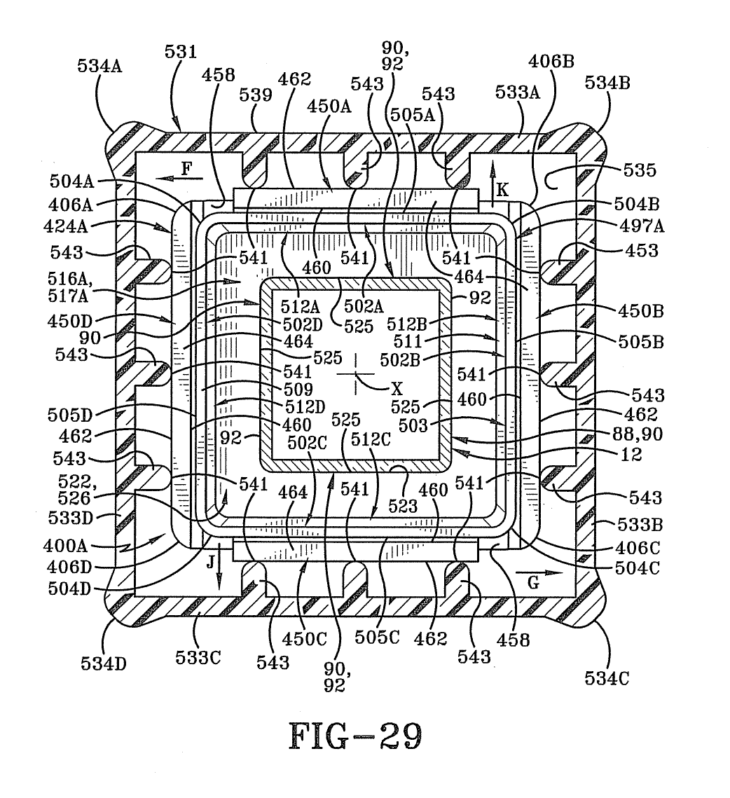

Fencing system 360A (FIG. 21) is similar to system 360 except that it has a post mount assembly 400A which is similar to and somewhat different than that of post mount assembly 400. Otherwise, system 360A includes the various other components of system 360 as described previously. More particularly, post mount assembly 400A includes a post insert 424A which is similar to but somewhat different than post insert 424, and expander wedge 497A which is similar to but somewhat different than wedge 497, and a second or lower post insert 425 which includes outward projections 26, which were previously described. The upper and lower post inserts 424A and 425 are vertically slidable up and down relative to post mount 12, as shown at Arrows L and M in FIG. 21. Post mount assembly 400A has a central vertical axis X shown in FIGS. 27-30 which is analogous to axis X of assembly 400 and is at the center of assembly 400.

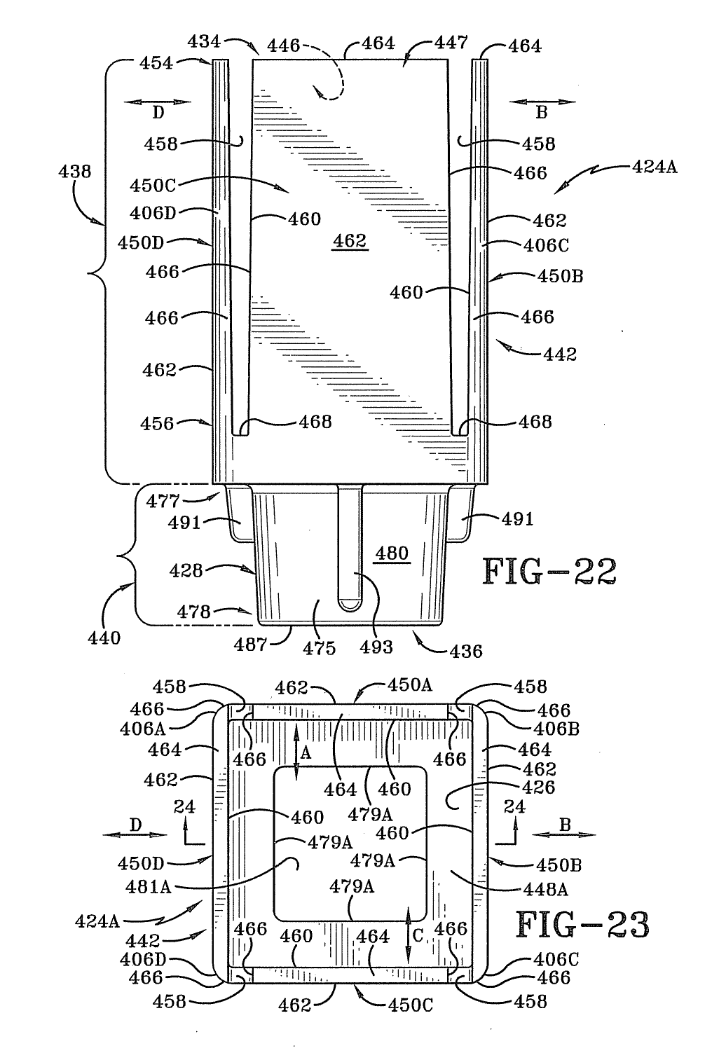

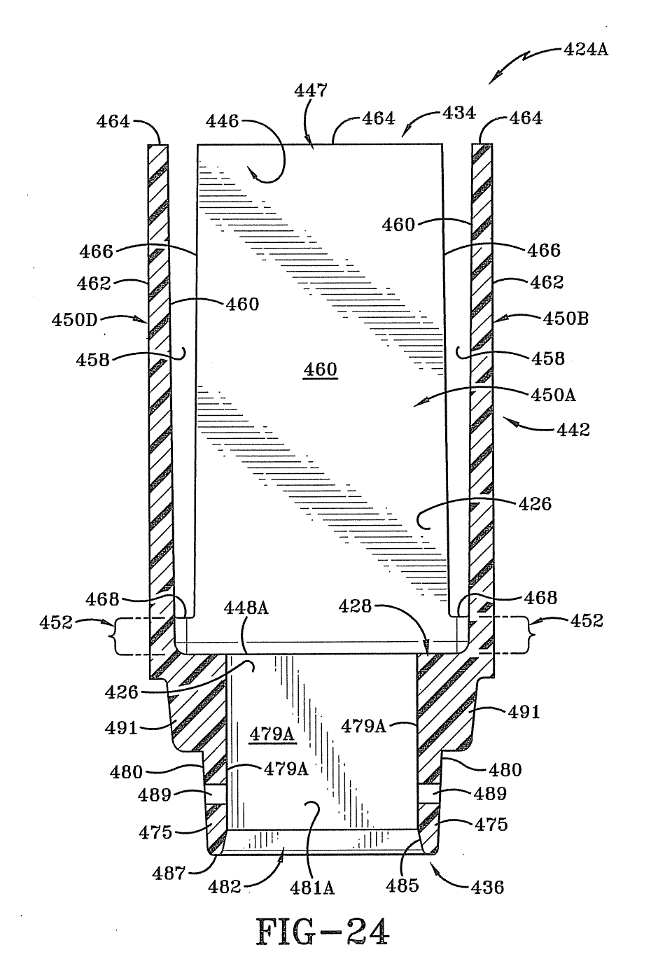

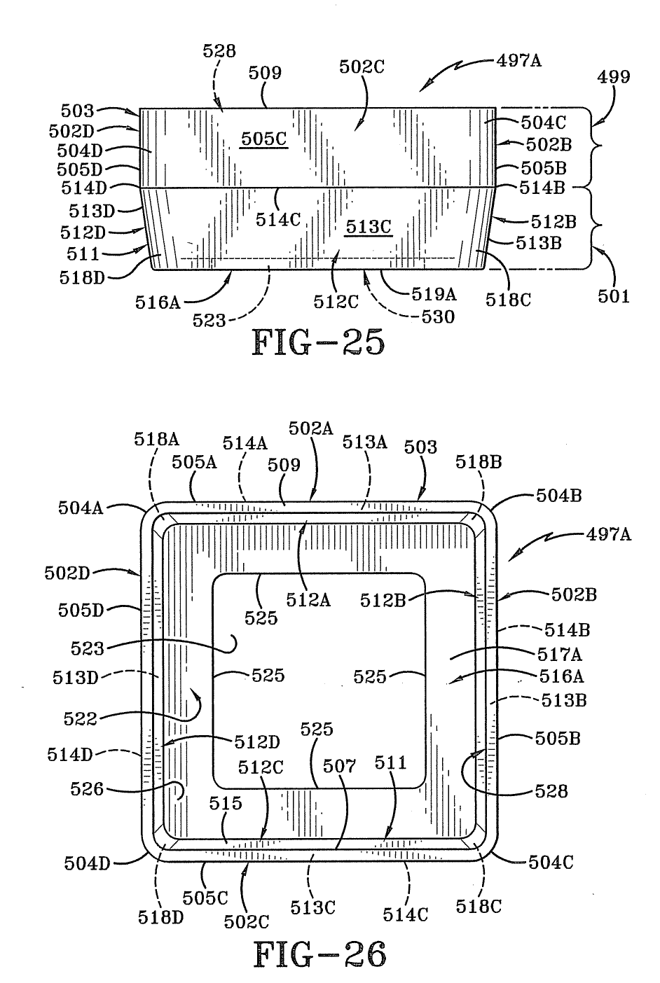

A comparison of FIGS. 22-24 with FIGS. 10-12 illustrates that post insert 424A is identical to post insert 424 except that a square central portion of side horizontal wall 444 is eliminated whereby post insert 424A defines a through hole, opening or passage 426 extending from top 434 to bottom 436. Axis X passes centrally through passage 426. Passage 426 includes upper post insert or side wall cavity 446 and a lower post insert or side wall cavity 481A which is similar to cavity 481 except that it has a greater height to the degree of the thickness of the eliminated portion of horizontal wall 444 of post insert 424. Thus, passage 426 includes an upper portion or cavity 446 which is wider than cavity 481A and which extends laterally from and beyond cavity 481A in all directions. Cavities 446 and 481A are square as viewed from above and thus have substantially the same shape. Post insert 424A includes a lower annular collar 428 which is substantially square in cross-section as viewed from above and which extends from bottom 436 to the bottom of cavity 446. Collar 428 thus extends from the bottom of lower section 440 to the top of section 440 and upwardly beyond the top of section 440 a short distance equal to the vertical thickness of the eliminated section of horizontal wall 444. It may thus be said that collar 428 forms the bottom portion of upper section 438, or that alternately that the top of collar 428 defines the top of lower section 440 and the bottom of upper section 438. In any case, column 428 has a substantially square annular horizontal upwardly facing top surface 448A which defines the bottom of cavity 446, the top of lower cavity 481A, and is at the height or point at which cavities 446 and 481A communicate with one another. Collar 428 thus includes four flat vertical inner surfaces 479A which are analogous to surfaces 479 of post insert 424 except that surfaces 479A extend to the top of collar 428 and thus intersect horizontal surface 448A. The upper portion of collar 428 and top surface 448A extend laterally outwardly beyond cavity 481A and the inner perimeter defined by surfaces 479A in all directions. Bottom section 452 of the upper section 438 is extends upwardly from adjacent the square outer perimeter of horizontal surface 448A. Fingers or walls 450 are spaced laterally outwardly of respective inner surfaces 479A.

A comparison of FIGS. 25-27 to FIGS. 13, 14 and 16 illustrates that wedge 497A is identical to wedge 497 except that key hole 521 is replaced by a substantially larger through opening 523 which is substantially square as viewed from above. Thus, wedge 497A includes a flat horizontal annular bottom wall 516A which is square as viewed from above and which has square flat annular horizontal top and bottom surfaces 517A and 519A which face respectively upwardly and downwardly. Annular bottom wall 516A thus has a substantially square annular inner surface or inner perimeter which defines through opening 523 and which more particularly includes four straight inner surfaces 525 such that one opposed pair of inner surfaces 525 are parallel to one another and another pair of inner surfaces 525 are parallel to one another and perpendicular to the first pair such that the four sides 525 intersect at four respective slightly rounded corners. Opening 523 has the same horizontal dimensions as opening 481A whereby inner surfaces 525 are vertically aligned respectively with inner surfaces 479A when post mount 400A is assembled. Top surface 517A defines the bottom of wedge cavity 522 and the top of through opening 523 whereby wedge 497A defines a through passage 526 which includes the wider wedge cavity 522 and narrower through opening 523 and thus extends from top 509 to bottom 519A of wedge 497. Through passage 526 has a top entrance opening 528 which is defined at top 509 and which also serves as the top entrance opening to wedge cavity 522. Passage 526 also has a bottom entrance opening 530 which is defined at bottom 519A and which also serves as the bottom entrance opening of through opening 523. Annular wall 516A, surfaces 517A and 519A, and upper wedge cavity 522 extend laterally outwardly from and beyond the lower wedge cavity or through opening 523 and inner perimeter 525 in all directions. The square side wall 503, 511 is spaced laterally outwardly of the inner perimeter defining opening 523 so that walls 502 and 512 are respectively spaced laterally outwardly of inner surfaces or edges 525.

Lower post insert 425 is described in greater detail with reference to FIG. 27. Insert 425 includes four outward projections 26 each including horizontal leg 94 and angled tab 96 which is rigidly secured to the outer end of a respective leg 94 and angles downwardly and outwardly therefrom. Insert 425 further includes a pair of opposed vertical connector tabs 95 rigidly secured to and extending upwardly from a pair of opposed legs 94. Each of tabs 95 has a vertical inner surface 97. A through hole 99 is formed through each vertical tab 95 extending from the inner surface 97 to the outer surface thereof. The four horizontal legs are rigidly secured to one another and together form a flat horizontal annular square wall which defines a through passage which receives post mount 12 when mounted thereon. Each angled tab 96 is rigidly secured to the outer end of one of legs 94. However, tabs 96 are not directly connected to one another and therefore define generally triangular spaces 101 therebetween respectively adjacent the four corners of the horizontal square wall formed by legs 94. Post insert 425 is typically formed of sheet metal so that the lower ends or outermost edges 98 of tabs 26 are able to flex inwardly and outwardly to some degree.

As previously noted, each of post inserts 424A and 425 are slidable vertically relative to post mount 12 during installation in order to set their appropriate respective heights. Thus, the installation of fencing system 360A typically begins with the securing of the lower end of post mount 12 to a floor or other foundation 14 such that post mount 12 extends vertically upwardly therefrom to its upper end 22. Lower post insert 425 is slid upwardly or downwardly with post mount 12 received in its through passage to the desired height in accordance with the desired height at which rail structures 34 are to be mounted. There is a sliding engagement between inner surfaces 97 of tabs 95 and the respective flat vertical outer flat portions 92 of outer surface 90 of post mount 12 during the vertical sliding movement of post insert 425. Once post insert 425 is positioned at the correct height, a threaded fastener 103 is inserted through each respective hole 99 and rotated so that the externally threaded shaft thereof threadedly engages an internally threaded hole 105 formed through side wall 88 of post mount 12. Holes 105 may be formed in side wall 88 prior to the positioning of post insert 425, or may be formed by the use of self-threading screws which serve as fasteners 103. In any case, fasteners 103 rigidly secure post insert 425 to post mount 12 at the desired height, thereby preventing vertical movement relative to post mount 12. Each fastener 103 extends from and through tab 95 to and through side wall 88 and is disposed in the corresponding holes 99 and 105.

Similarly, the upper post insert 424A is moved vertically downwardly from a position above the top 22 of post mount 12 so that top 22 is received through bottom entrance opening 482 into through passage 426. Post insert 424A may be vertically adjusted upwardly or downwardly relative to post mount 12 during which there is a sliding engagement between inner surfaces 479A and the flat vertical portions of outer surface 90 of side wall 88 of post mount 12. Like post insert 425, post insert 424A is vertically adjusted to position it at a desired height associated with the desired height of upper rail structures 32 (FIG. 21). Once post insert 424A is positioned at the correct height, fasteners such as threaded fasteners 490 are inserted through respective holes 489 and rotated to threadedly engage holes 549 formed though side wall 88 of post mount 12. Like holes 105, holes 549 may be formed in post mount 12 prior to the positioning of post insert 424A or after post insert 424A reaches the correct position. Holes 549 may also be formed by a self-threading fastener 490. Each fastener 490 is thus disposed in the corresponding holes 489 and 549 and extends from and through collar 428 to and through side wall 88. Fasteners 490 thus rigidly secure post insert 424A to post insert 12, thereby preventing vertical movement of post insert 424A relative to post mount 12. Depending on the desired height of post insert 424A, top 22 of post mount 12 may be disposed within lower cavity 481A, upper cavity 446 or wedge cavity 522 and thus may be within through passages 426 and 526 during or after assembly. Alternately, top 22 may be disposed above the top 464 of post insert 424A and top 509 of wedge 497A during assembly or when post mount assembly 400A is assembled.

Generally, wedge 497A works in the same manner when inserted into post insert cavity 446 to slidably engage the walls or fingers 450 and force them laterally outwardly away from axis X and against the tips 541 of ribs 543 as previously described. However, like lower cavity 481A of post insert 424A, through opening 523 of wedge 497A is substantially the same shape as and slightly larger than the outer surface 90 of post mount 12 so that the inner surface of annular wall side 16A slidably engages the outer surface 90 of post mount 12 during the movement of wedge 497A relative to post mount 12. More particularly, this sliding engagement typically occurs during the vertical movement of wedge 497A relative to post mount 12 when post mount 12 is received within through opening 523. The user thus lowers wedge 497A so that top 22 of post mount 12 is received through bottom entrance opening 530 so that bottom wall 516A is moved to a position lower than top 22 and typically so that top 22 passes through top entrance opening 528 such that top 509 of wedge 497A ends up at a height lower than that of top 22 in the assembled state of post mount assembly 400A.

When post mount assembly 400A is assembled and received within post 28, inner surfaces 97 of tabs 95 engage the other surface 90 of post mount 12 while the lower outermost edges 98 of tabs 96 engage the inner surface or tips 541 of post 28. In addition, inner surfaces 479A respectively engage the flat outer surfaces 92 of post mount 12 while fingers or walls 450 and their respective inner and outer surfaces are spaced outwardly of the outer surface 90 of post mount 12. Thus, the inner surfaces of fingers 450 and the outer surface 90 of post mount 12 define therebetween an annular cavity which is the outermost portion of post insert cavity 446. Top surface 448A extends laterally outwardly in all directions from adjacent outer surface 90. In addition, the inner perimeter of bottom wall 516A of wedge 497A engages outer surface 90 with inner surfaces 525 respectively engaging the outer flat portions 92 of post mount 12. Wall 516A and its upper and lower surfaces 517A and 519A extend laterally outwardly in all directions from adjacent outer surface 90. Side wall 503, 511 and the inner and outer surfaces thereof are spaced laterally outwardly of outer surface 90 of post mount 12. All or part of wedge 497A is received within the annular cavity or outer portion of post insert cavity 446 defined between outer surface 90 of post mount 12 and the inner surfaces of fingers 450. Wedge member 497A in its entirety is spaced inwardly of the inner surface of post 28, including the tips 541 of ribs 543. In the exemplary embodiment, all portions of post inserts 424A and 425 are spaced inwardly of the inner surface of post 28 except for the outermost lower edges 98 of lower post mount 425 and the upper portions of fingers 450 adjacent the upper ends 464 thereof.

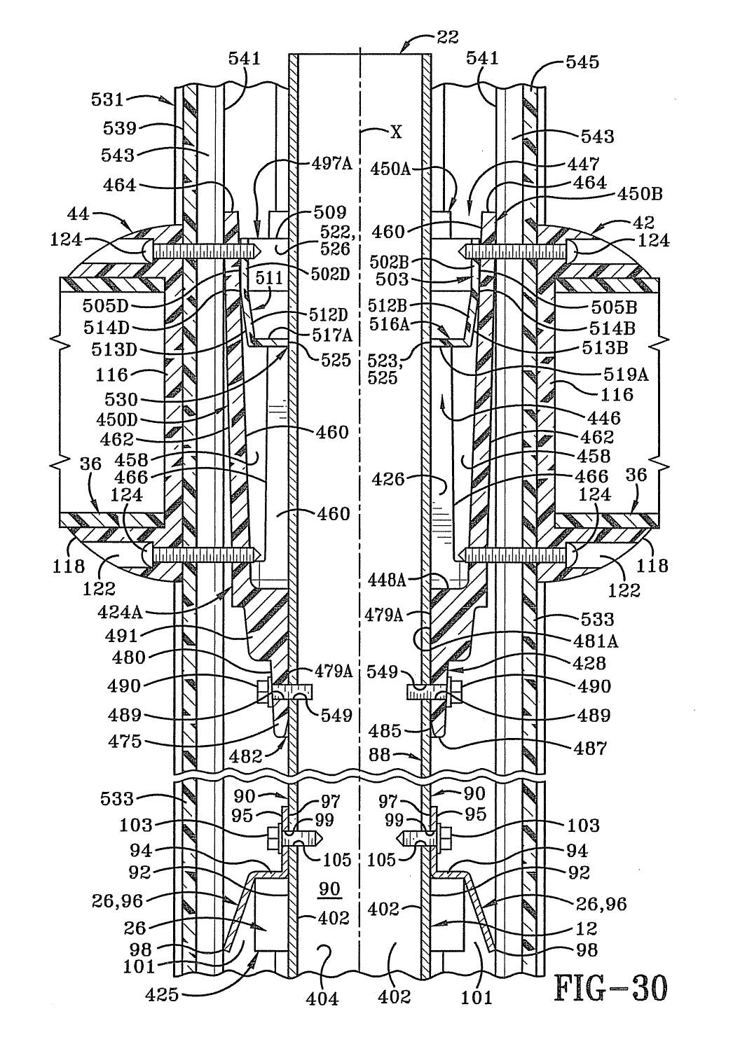

Once post mount assembly 400A is assembled and the upper post insert 424A is wedged against the inner surface of post 28, the rail structures are mounted on the given post with the mounting brackets 42, 44, 52 and 54 mounted in the same manner as previously discussed. Thus, as shown in FIG. 30, the screws 124 secure the corresponding brackets 42 and 44 to the walls 533 of the post and walls 450 of the post insert 424A and the side walls of wedge 497A in the same manner as discussed with respect to post insert 424 and wedge 497 (FIG. 20). However, unlike the configuration of post insert 424 and wedge 497 shown in FIG. 20, FIG. 30 illustrates that screws 124 are positioned below the top 22 of post mount 12 with the tips of screws 124 disposed directly between the outer surface 90 of post mount 12 and the respective walls 450 and 533 and the respective bracket 42 or 44. In addition, the tips of the upper screws 124 are positioned directly between the outer surface 90 and the corresponding wall 502 of the side wall of wedge 497A. As shown in FIG. 21, the lower post insert 425 is positioned directly between the corresponding lower rail mounting brackets 52 and 54 when the corresponding rail structures are mounted thereon. Likewise, the post insert 424A is positioned directly between the upper rail mounting brackets 42 and 44 in the upper rails 36 mounted thereon. FIG. 21 further shows that the other post insert 424A may be positioned at a different height, as illustrated by height H2 of the bottom of the upper section of post insert 424A, in contrast to height H1 shown in FIG. 9. Due to the vertical adjustability of both post inserts 424A and 425, the upper and lower rail structures may be positioned at any desired height along the hollow post of the present system.

In the foregoing description, certain terms have been used for brevity, clearness, and understanding. No unnecessary limitations are to be implied therefrom beyond the requirement of the prior art because such terms are used is for descriptive purposes and are intended to be broadly construed.

Moreover, the description and illustration of the invention is an example and the invention is not limited to the exact details shown or described.

1. A fencing system comprising:
a post mount assembly having an upper end and a lower end adapted to mount on a foundation;
a post having an inner surface defining a post cavity in which the post mount assembly is slidably receivable;
a post mount of the post mount assembly;
a first wall of the post mount assembly which is vertically slidable relative to the post mount; and
to a wedge of the post mount assembly which is movable relative to the post mount and first wall from a first position to a wedged position in which the wedge is wedged against the first wall.

2. The system of claim 1 wherein the post mount assembly is forced against the inner surface of the post in response to movement of the wedge from the first position to the wedged position.

3. The system of claim 1 wherein the post mount assembly has a central vertical axis; and the post mount assembly moves away from the central vertical axis in response to movement of the wedge from the first position to the wedged position.

4. The system of claim 1 wherein in the wedged position the wedge is wedged between the post mount and first wall.

5. The system of claim 1 further comprising
a top and bottom of the wedge; and
a through passage formed in the wedge from the top to the bottom;
wherein the wedge is downwardly movable relative to the post mount with the post mount received in the through passage.

6. The system of claim 1 further comprising
an outer surface of the post mount;
a sidewall which comprises the first wall and is positioned outwardly of the outer surface of the post mount;
an inner surface of the sidewall defining a sidewall cavity;
wherein the wedge is within the sidewall cavity in the wedged position.

7. The system of claim 1 further comprising
an outer surface of the post mount; and
a sliding engagement between the wedge and outer surface of the post mount.

8. The system of claim 1 further comprising a sliding engagement between the wedge and first wall during movement of the wedge from the first position to the wedged position.

9. The system of claim 1 further comprising a sliding engagement between the wedge and first wall which translates downward movement of the wedge into horizontal movement of the post mount assembly.

10. The system of claim 1 wherein the first wall is substantially flat and vertically oriented.

11. The system of claim 1 wherein the first wall flexes in response to movement of the wedge from the first position to the wedged position.

12. The system of claim 1 further comprising
a post insert which comprises the first wall and is vertically slidable relative to the post mount;
an outer surface of the post mount; and
a sliding engagement between the post insert and outer surface of the post mount.

13. The system of claim 1 further comprising
a post insert which comprises the first wall and has a top and bottom;
a through passage formed in the post insert from the top to the bottom;
wherein the post insert is vertically movable relative to the post mount with the post mount received in the through passage.

14. The system of claim 1 further comprising
a post insert of the post mount assembly; and
a first section of the post insert;
wherein the first wall is cantilevered from the first section; and
the first wall moves in response to movement of the wedge from the first position to the wedged position.

15. The system of claim 14 further comprising a second wall which is cantilevered from the first section;
wherein the second wall moves in response to movement of the wedge from the first position to the wedged position.

16. The system of claim 1 further comprising a second wall of the post mount assembly;
wherein the first wall moves in a first direction in response to movement of the wedge from the first position to the wedged position; and
the second wall moves in a second direction different from the first direction in response to movement of the wedge from the first position to the wedged position.

17. The system of claim 1 further comprising a securing mechanism for securing the first wall to the post mount at a selected height.

18. The system of claim 17 further comprising a post insert which comprises the first wall and is vertically slidable relative to the post mount;
wherein the securing mechanism comprises a fastener extending from the post insert to the post mount.

19. A fencing system comprising:
a post mount assembly comprising a post mount having an upper end and a lower end adapted to mount on a foundation;
a post having an inner surface defining a post cavity in which the post mount assembly is slidably receivable;
a first wall of the post mount assembly;
a wedge of the post mount assembly which has a top and a bottom;
a through passage formed in the wedge from the top to the bottom;
wherein the wedge is downwardly movable relative to the post mount with the post mount received in the through passage from a first position to a wedged position in which the wedge is wedged against the first wall.

20. A method comprising the steps of:
securing a lower end of a post mount assembly to a foundation so that the post mount assembly extends upwardly from the foundation;
inserting the post mount assembly into a post cavity defined by an inner surface of a post; and
wedging a wedge of the post mount assembly against a first wall of the post mount assembly to force the post mount assembly against the inner surface of the post.
